(19) United States
(12) Patent Application Publication
(10) Pub. No.: US 2026/0087819 A1
(43) Pub. Date: Mar. 26, 2026

(54) Retail AGI Surveillance Replacement System (RAGIS-RS) for Symbolic Consent-Governed Behavior Monitoring and Privacy-Preserving Analytics

(71) Applicant: Samuel Odeh, Burr Ridge, IL (US)

(72) Inventor: Samuel Odeh, Burr Ridge, IL (US)

(21) Appl. No.: 19/390,505

(22) Filed: Nov. 15, 2025

(51) Int. Cl. G06V 20/52; G06F 21/34; G06V 40/20

(52) U.S. Cl. CPC G06V 20/52; G06F 21/34; G06V 40/20

(57) ABSTRACT

A privacy-preserving retail monitoring system employing symbolic artificial intelligence for non-identifying behavioral analysis is disclosed. The system includes a 360-degree multimodal sensing assembly configured to capture optical, thermal, acoustic, and depth data, an onboard symbolic execution kernel that converts sensor input into non-biometric behavioral glyphs, and a consent-governed classification module enforcing role-based and jurisdiction-specific privacy rules. Behavioral events are evaluated through a programmable policy directed acyclic graph, enabling real-time redaction, escalation, or suppression without generating facial recognition, identity vectors, or raw audio transcripts. A hardware-enforced redaction subcircuit blocks non-compliant outputs from storage or transmission, while encrypted audit trails capture only symbolic paths and consent states. The system executes fully at the edge, supports compliance replay capsules, and outputs redacted analytics suitable for safety, loss prevention, and operational analysis. Modular installation formats permit deployment across retail, convenience, and fuel environments as a drop-in replacement for legacy surveillance hardware.

The system consists of a spherical omnidirectional sensor array encapsulated within an orbiform housing mounted to a retail ceiling structure. The sensor array includes a compound optical module, a thermal imaging layer, a near-field audio capture ring, and skeletal lidar band. These modules operate concurrently to produce a fused multimodal perception field. Signal fusion occurs on-device via a symbolic AI processing kernel that maintains a stateful representation of all tracked individuals within the retail space.

Each tracked individual is abstracted into a symbolic entity composed of motion vectors, behavioral predicates, trajectory clusters, and environmental relationships. Identity is not stored; instead, semantic abstractions are derived from behavior rather than biometric signature. The symbolic AI kernel maintains a dynamic behavior graph per entity, where edges represent predicate-confirmed transitions between action states, and nodes are labeled with posture class, location context, and timecode.

Consent-state is initialized upon entry into the retail space through passive presence-detection using environmental markers. A default consent-capsule is associated with a symbolic class (e.g., customer, staff, vendor) and modulates how data from the individual is interpreted and retained. Consent policies are dynamically applied based on proximity to protected zones (e.g., bathrooms, staff rooms), and time-of-day regulatory overlays (e.g., night shift privacy thresholds). Each capsule includes a hash-locked symbolic token that indexes applicable redaction protocols, audit rules, and escalation permissions.

The policy engine interfaces with a programmable DAG (directed acyclic graph) structure where each node represents a behavioral classification rule and each edge encodes a policy conditional. Spikes in behavior graphs are routed through the DAG for validation. If the symbolic path violates a conditional (e.g., proximity breach without consent), the system redacts the segment in real time and logs a symbolically scrubbed event instance.

Redacted instances do not store optical, thermal, or audio data. Instead, symbolic representations are stored with trust-level annotations, temporal position, and DAG path tags. These form the audit trail used for insurance, compliance, or arbitration purposes. Redaction granularity is dynamically adjusted based on user role, behavior severity, and store-specific risk profile.

Employee surveillance is gated by contractual consent and bounded temporal scopes. Consent capsules are activated via badge proximity or authenticated wearable input. During off-hours, the system does not log employee movement unless system-wide incident threshold is triggered. The symbolic kernel tags all employee actions with a shift-based UUID and policy ID for post-hoc review without persistent recording.

The AI model does not infer emotion or identity. Instead, it classifies symbolic behaviors such as “loiter,” “abrupt motion,” “unauthorized zone breach,” “non-stationary crowd convergence,” or “item displacement without checkout event.” These labels are not deterministic but are subject to confidence scoring derived from motion topology, velocity anomaly, and thermal deviation patterns. Events above severity threshold trigger a consent check before action is taken.

The symbolic kernel is containerized and executes on a local AI edge accelerator board within the device. All training data is synthetic or procedurally generated; no customer video or audio is retained or sent to external servers. Consent-gated system updates are applied during non-operating hours, and policy DAGs are version-locked to enable forensic audit replay.

The redaction subcircuit is implemented as a dedicated logic pathway within the edge-AI processor, isolated from the primary inference module by a hardware-enforced trust barrier. Its function is to intercept, truncate, or transform output frames, audio segments, and skeletal sequences based on policy-matched consent state. Redaction logic is triggered if the symbolic representation crosses any severity gate within the active policy DAG and lacks a valid consent token or override key.

The redaction engine evaluates symbolic states using a layered filter system: posture filters (e.g., recline, collapse), location filters (e.g., restroom boundary, off-lane zones), velocity thresholds (e.g., panic motion), and aggregate anomalies (e.g., multiple entities clustering unexpectedly). Each filtered trigger propagates a redaction signal across the corresponding time window, marking adjacent frames within the temporal buffer for scrubbing or symbolic substitution.

Upon redaction trigger, the system replaces multimodal input with tagged symbolic artifacts: a motion glyph representing direction, a confidence score vector, a context label, and a policy ID hash. This symbolic abstraction replaces visual/audio data in the output stream. All redactions are tagged with a system-unique Redaction Event Capsule (REC), which includes timestamp, reason code, policy branch, and trust gradient score. These RECs are cryptographically signed and added to a Redaction Ledger Block (RLB).

The RLB functions as a sequential, append-only record of every consent-driven modification enacted by the system. Each block is signed with a device-unique hardware root key and optionally broadcast to a cloud-based policy observer or third-party insurer node for compliance review. In jurisdictions with strict redaction mandates, the RLB can be mirrored to a physically separate secure enclave within the store or transmitted via air-gapped removable media.

To prevent tampering, each RLB incorporates a Merkle tree digest of all RECs included within its window. This ensures forensic integrity, allowing external validators to confirm that redactions align with DAG policy and time-synced context. If any deviation or unauthorized override occurs, it is flagged during audit replay using root-level comparison between REC-digest and consent-DAG hash snapshot.

Severity propagation is handled through a symbolic thresholding layer that monitors the entropy and behavioral volatility across each subject's symbolic state buffer. If the symbolic noise floor rises beyond a programmable threshold (e.g., unexpected hand motion, high vocal variance, temperature spike), the consent engine enters a “cautionary redaction mode” where all sensor outputs are preemptively symbolized until behavior stabilizes or override is confirmed.

Override events require policy-signed authorization, either from an on-site administrator capsule, pre-approved automated override list (e.g., loss prevention mode), or external override signature (e.g., police warrant token or legal audit trigger). In such cases, the redacted data may be partially reconstructed from short-term encrypted RAM if temporal proximity and legal thresholds are met.

The entire redaction subcircuit operates under real-time constraints, with a latency budget of <100 ms per event propagation loop. Critical sections are optimized with low-level parallel DAG traversal logic and symbolic pattern-matching ASIC acceleration, enabling seamless runtime enforcement at 30 FPS optical frame rates with no perceptible delay in customer-facing operations.

The symbolic behavior tagging engine utilizes a spatiotemporal abstraction pipeline that maps incoming sensor data into discrete behavior classes without reliance on biometric identifiers. Optical frames are decomposed into motion primitives via background-subtracted keypoint detection, followed by frame-differenced pose estimation. These primitives—such as “reach,” “turn,” “linger,” “approach,” and “exit”—are encoded into symbolic glyphs representing unit behaviors.

Each glyph is timestamped and placed into a rolling temporal buffer aligned with entity UUIDs maintained by the symbolic kernel. The system uses a convolutional memory encoder to detect recurrent glyph patterns that match known behavior signatures stored in a policy-aware Symbolic Gesture Library (SGL). This library is hierarchical, allowing abstract behaviors like “purchase attempt” or “employee assist” to be composed from lower-level glyph chains like “reach→grasp→reverse motion→handover.”

Skeletal action encoding is performed by the integrated LIDAR and thermal modules, which generate per-frame skeletal maps at ˜20 Hz and assign thermographic signatures to distinguish humans from inanimate motion. These skeletal maps include joint angles, limb vectors, gait cycles, and occlusion status. Symbolic overlays tag key joints—hands, shoulders, hips, knees—allowing for classification of gestures, postures, and proximity-based interactions.

Gait analysis is embedded into symbolic state as a background identity token used only for movement prediction, not recognition. If gait signature confidence falls below the symbolic entropy threshold, predictive routing falls back to gesture context and environmental cues rather than re-identification. This prevents unintentional biometric anchoring and upholds consent-defined redaction domains.

Behavior sequences are assigned a symbolic trust vector based on context (e.g., zone classification), temporal stability, and deviation from baseline store patterns. The trust vector is a four-dimensional floating-point tuple representing:
(i) motion stability (0-1),
(ii) zone legality (0-1),
(iii) behavior-predicate match score (0-1),
(iv) proximity volatility (0-1).
   This vector feeds into downstream escalation logic and redaction modulation layers.

Trust vector magnitudes below a programmable policy floor trigger caution mode, in which all subsequent behavior glyphs are soft-redacted and recoded into symbolic-only storage until environmental normalization. These precautionary reductions reduce liability during ambiguous activity windows and are reversible with audit-token review.

The system supports symbolic gesture fusion, in which simultaneous inputs—e.g., hand movement, body orientation, and thermal flux—are aggregated into unified behavior estimates. Each fused glyph is assigned a Confidence Density Score (CDS), updated recursively as new sensor input refines the symbolic edge weights.

CDS values govern automatic fallback to symbolic summaries when sensory ambiguity arises (e.g., occlusion by shelving, or poor lighting). These symbolic summaries carry timestamp metadata, entity UUID, and glyph chain hashes, and are logged to the real-time Policy Compliance Queue for DAG traversal and potential human review.

The policy DAG is a directed acyclic graph data structure encoding hierarchical decision-making logic for behavior classification, redaction thresholds, and escalation triggers. Each node represents a symbolic rule (e.g., “proximity breach in secure zone”), while edges represent conditional transitions based on trust vector deltas, posture glyphs, or consent-capsule status. This modular structure allows for dynamic policy tuning across retail, jurisdictional, or temporal contexts.

Upon ingestion of a new symbolic glyph chain, the DAG traversal module initiates a recursive descent from root policy nodes associated with the subject's role (e.g., customer, staff, vendor). As the symbolic chain is parsed, conditional branches are followed using current sensor input, behavior trust vectors, and recent DAG traversal history. The DAG maintains a short-term symbolic memory window (˜5 s) to enable pattern recognition and prediction beyond frame-by-frame inference.

Each policy node is versioned and time-stamped, with jurisdictional override markers allowing for geofenced modifications. Nodes include enforcement metadata such as redaction scope, alert escalation priority, and auto-override lockout timers. If traversal reaches a terminal node marked “redact,” the redaction subcircuit is invoked with full context of path history, triggering symbolic substitution or live redaction according to the prescribed enforcement level.

Consent-capsules are cryptographically bound to DAG traversal instances using a hash-linking mechanism. Each behavior classification event includes the consent capsule ID, a Merkle hash of the capsule's active parameters (e.g., shift window, override status), and a trust-level proof-of-context. This guarantees that redaction or retention decisions made by the system are traceable to valid consent boundaries and prevent retroactive tampering.

Audit replay synchronization is facilitated by the Policy Replay Engine (PRE), which reconstructs symbolic events using stored DAG snapshots, consent capsule hashes, and symbolic glyph logs. PRE operates in two modes:
(i) compliance replay, which checks historical actions against current policy revisions to determine regulatory drift, and
(ii) legal review, which generates deterministic reconstructions of redacted events using cryptographic proofs.

During audit playback, symbolic glyph chains are rendered on a compliance interface alongside the original DAG path taken, the consent capsule ID, redaction flags, trust vectors, and override keys (if any). This data can be exported to third-party review boards, legal auditors, or insurance carriers in encrypted audit capsules, preserving chain-of-trust.

The DAG traversal kernel supports real-time dynamic reconfiguration, allowing external policy updates (e.g., new regulation or seasonal store policy) to be applied midstream without halting operation. Any DAG policy node introduced during runtime is soft-forked and logged with a policy snapshot, preventing collision with existing traversal states.

Symbolic states during DAG traversal are cached with a 2-minute temporal leash and expunged unless marked by incident flags. This ensures memory-efficient symbolic operation while maintaining replayability for incidents within the standard liability reporting window.

The edge device architecture is centered around a tamper-resistant spherical chassis housing the core symbolic processor, multimodal sensor arrays, and an isolated hardware cryptographic root. The chassis is constructed from RF-shielded polymer with integrated vibration dampening, ensuring signal fidelity and physical durability in retail ceiling mounts. Power is delivered via low-voltage PoE (Power over Ethernet) with internal fallback capacitors to ensure continued operation during short power disruptions.

The internal compute module is anchored by a multi-core AI inference SoC with a dedicated symbolic coprocessor. The coprocessor executes real-time symbolic behavior parsing and DAG traversal independent of the image processing pipeline. Sensor fusion and skeletal inference operate in parallel, using shared memory buffers guarded by role-specific access control units (ACUs) to enforce segmentation between sensory, symbolic, and cryptographic operations.

A dedicated cryptographic root-of-trust (RoT) module is embedded in silicon and used to sign all redaction events, consent-capsule bindings, and symbolic audit trails. This RoT module includes a true random number generator (TRNG), secure key storage, and hardware accelerators for SHA-3, ECDSA, and Merkle tree construction. Upon boot, the RoT module attests the system firmware, policy DAG, and symbolic inference kernel, sealing any unauthorized modification attempts.

Fault isolation is handled through a compartmentalized process mesh in which each subsystem—optical processing, symbolic tagging, policy evaluation, redaction, and networking—executes in sandboxed memory with hardware-controlled data diodes preventing bidirectional leakage. For example, image data is never permitted to flow back into symbolic storage without policy-tagged routing, and redaction outputs cannot be accessed without signed DAG justification.

The system is equipped with a real-time thermal anomaly detection loop that automatically engages fault tolerance protocols if sensor drift, device overheating, or adversarial behavior (e.g., laser tampering) is detected. In such events, the device enters a hardened symbolic-only mode, suspending video/audio capture and continuing symbolic inference using prior trust vector priors and behavioral projection models.

The networking subsystem is isolated in a zero-trust enclave and communicates using TLS 1.3+ with ephemeral keying. All outbound data—including symbolic glyphs, audit capsules, and configuration pulls—is wrapped in consent-bound envelopes signed by the RoT. In high-security installations, outbound transmission can be hardware-disabled, forcing full offline operation with data export limited to physically authenticated retrieval tokens.

Local storage is encrypted using XTS-AES-256 and partitioned between real-time buffers, symbolic archives, and compliance logs. The partitioning is enforced by firmware-encoded file system boundaries, verified on each boot by hash-tree validation. Logs older than the consent-defined retention period are automatically purged, with an audit trail entry documenting the deletion action signed by the system's internal DAG hash snapshot.

Firmware updates are applied through a staged mechanism, requiring dual signatures—one from the manufacturer and one from the policy regulator or store administrator. During updates, the symbolic kernel is held in a read-only memory state while DAG and capsule schemas are soft-locked, ensuring operational integrity even during mid-operation patching cycles.

Jurisdictional policy overlays are modular regulatory templates applied atop the base policy DAG to align system behavior with regional data privacy laws, biometric usage statutes, and consent frameworks. Each overlay is structured as a linked node tree that modifies traversal outcomes by introducing conditional substitutions, threshold shifts, or redaction mandates. For example, within GDPR territories, the overlay disables long-term symbolic trust tracking and shortens symbolic glyph retention windows to 24 hours unless a policy-triggered event occurs.

These overlays are stored as signed modules issued by regulatory authorities, legal entities, or corporate compliance officers. Each overlay is indexed by jurisdictional code (e.g., EU-GDPR-2025-A2) and signed by a double-key authority structure: one key derived from a policy consortium (e.g., ENISA, NIST) and another from a device-fleet administrator. Only verified overlays with valid signatures can be loaded into active traversal memory.

When the edge system boots or re-enters operation after downtime, it checks GPS location and administrative settings to determine applicable overlays. If the location is ambiguous, a failsafe privacy-maximal overlay is applied. Multiple overlays can stack (e.g., California+Franchise Policy), and if conflicts arise, the system follows the path with the highest redaction threshold.

The symbolic AI kernel supports multilingual symbolic token packs, enabling gesture and behavior tagging across culturally diverse contexts. Each token pack is a lexicon mapping physical gestures, posture chains, and interactions to semantic labels in the relevant linguistic or cultural framing. For instance, a “bow” in Japanese retail would carry different symbolic metadata than in Western contexts.

Each token pack is versioned and includes region code, language identifier, cultural context flags (e.g., formal/informal), and override maps for behavioral ambiguity. Symbolic inference uses the active token pack to translate sensor-derived motion glyphs into localized semantic interpretations that are then processed by the policy DAG. This ensures consistent behavior classification while respecting regional norms.

The system includes a Token Consistency Engine (TCE) that compares real-time glyph labeling with prior instances across the jurisdiction to maintain classification consistency. This engine flags token drift (e.g., gesture misclassification due to cultural mismatch) and logs divergence events for downstream audit. Administrators can push token pack updates to address emerging gestures or reinterpretations due to sociocultural changes.

For global compliance, symbolic logs and redaction ledgers are exportable in ISO-standard audit capsule formats (e.g., ISO/IEC 27001-compatible symbolic archives). Each export includes machine-readable schemas, jurisdictional overlay references, symbolic DAG snapshots, and hash-verified glyph chain histories. These can be submitted to compliance portals, regulatory sandbox environments, or internal enterprise auditors.

During multi-jurisdiction operation—e.g., a global retail chain deploying the system across North America, EU, and Asia—each device is fleet-synchronized using a geofence-aware policy orchestrator. This orchestrator pushes overlay updates, token pack changes, and policy soft-forks based on regional constraints and store policy changes, ensuring all symbolic behavior analysis remains compliant at the edge.

The AI model architecture at the core of the system employs a hybrid symbolic-neural framework optimized for real-time multimodal inference on edge hardware. It consists of three tiers: (i) raw signal ingestion and preprocessing, (ii) gesture and behavior extraction via neural embeddings, and (iii) symbolic abstraction and graph integration via a rule-driven logic layer. Each tier operates asynchronously using dedicated tensor compute units and symbolic processors, with shared memory buffers secured via access tokens linked to consent state.

The neural base model uses a quantized transformer encoder adapted for event-driven sensor inputs. Instead of conventional frame-based video processing, the model is triggered by motion deltas, thermal shifts, or acoustic fluctuations. This design drastically reduces inference overhead and improves privacy compliance by processing only necessary data. The transformer operates with positional encodings derived from spatial-skeletal maps, allowing learned attention across body joints, environmental zones, and interaction sequences.

Model training is performed exclusively on synthetic datasets generated via procedurally randomized retail simulation environments. These simulations include thousands of human movement patterns, gestures, thermal profiles, and environmental layouts. Synthetic actors are assigned symbolic roles (e.g., “loiterer,” “staff,” “shopper”), and behavior scripts are rendered using photorealistic game engines with symbolic annotation layers. This ensures no real-world biometric data is used in pretraining or finetuning.

Each simulation session generates a multimodal bundle: optical flow maps, depth clouds, thermographic timelines, audio fingerprints, and skeletal paths, all tagged with ground-truth symbolic glyphs. These are used to pretrain the neural transformer on multimodal attention alignment and symbolic embedding prediction. Symbolic encoders are then trained to map latent embeddings into glyph chains, behavioral confidence scores, and policy DAG traversal paths.

To counter symbolic falsification—where adversarial gestures or spoofing attempts mimic normal behavior—the system incorporates resilience layers using contrastive learning. During training, a discriminator network evaluates whether symbolic sequences match expected context (e.g., thermal-emotion congruence, gait plausibility, multi-agent trajectory coherence). Sequences flagged as incongruent are automatically downweighted or passed to a second-tier classifier.

The symbolic falsification defense system also includes anomaly detectors trained on latent activation paths rather than output predictions. These detectors analyze transformer attention heatmaps and compare them against known valid glyph transitions. Abrupt activation divergence (e.g., excessive attention on single joint, or reversed motion sequence) flags the input for runtime redaction and trust vector decay.

Further resilience is achieved via glyph consensus voting across sensor modalities. For example, if optical motion suggests “reach,” but thermal and skeletal signatures conflict (e.g., hand not warm, arm not extended), the symbolic glyph is withheld or replaced with a null symbol. This tri-modality consensus engine runs in parallel with symbolic tagging and ensures robustness even under occlusion or spoofed video input.

Post-deployment, models receive continuous feedback in the form of symbolic confidence distributions, redaction frequency analytics, and DAG traversal density maps. This feedback is processed offline to retrain future versions of symbolic classifiers—without storing any sensitive inputs—and push signed updates via the consent-governed model lifecycle system.

The system employs a multimodal sensor calibration routine to maintain precise alignment across optical, thermal, acoustic, and skeletal streams. Each sensor modality is mounted at fixed orientations with cross-referenced origin points relative to the central symbolic processor. Calibration initiates at boot and executes hourly micro-adjustments using internal reference patterns, environmental baselines, and behavioral symmetry checks.

Optical sensors are calibrated using contrast edge detection against known ceiling and shelving geometries. The system uses high-contrast fiducial marks embedded in the environment or infrared pattern emitters to ensure sub-pixel alignment of visual frames. Thermal sensors are offset-corrected based on ambient temperature drift and emissivity scans from passive surfaces (e.g., tiles, wall paint), ensuring accurate temperature overlays on skeletal forms.

Acoustic arrays are synchronized using phase-shift triangulation from ambient sound pulses. If a sound anomaly is detected (e.g., sudden impulse or sustained tone), delay calculations across microphones refine spatial sound placement. This enables accurate directional gesture tagging (e.g., “caller turned left”) and ensures spatial trust vectors integrate auditory variance.

Skeletal mapping modules are continuously recalibrated using gait-loop symmetry and biometric anchorless modeling. The symbolic kernel maintains a rolling histogram of limb vector consistency and posture transition latency to detect drift. If anomalies appear—such as a persistent limb offset or unexpected jump in joint velocity—the system initiates a silent recalibration cycle, suspending symbolic glyph generation until re-stabilization completes.

Synthetic benchmarking is performed weekly during off-hours. The system loads a pre-scripted symbolic simulation pack: a synthetic glyph stream replayed through the inference pipeline while sensor inputs are muted. This synthetic benchmark tests latency, redaction triggers, DAG traversal, and fault logging. Performance is compared against expected symbolic outputs, with deviations flagged for administrator inspection or fleet-wide firmware adjustment.

The symbolic fusion engine uses a redundancy-weighted model to merge data from all sensors into unified glyphs. Each modality contributes a confidence score based on environmental signal quality, time drift, and modality-specific error detection. For example, if thermal signature drops due to HVAC flow or glass interference, the fusion engine deprioritizes thermal input in gesture inference, leaning instead on skeletal and optical cues.

Fusion decisions are made via a trust consensus protocol that computes a weighted average confidence vector across modalities. If the vector falls below the symbolic certainty threshold, the glyph is redacted or downgraded to a symbolic placeholder. Each decision is timestamped, tagged with contributing modality hashes, and appended to the Symbolic Fusion Ledger (SFL), a local proof record of sensory trust reconciliation.

The system logs modality confidence histograms over time to identify sensor degradation or tampering. If a sensor persistently underperforms (e.g., optical glare during sunset), a policy-determined de-weighting can be enforced, and the DAG modified to account for modal reduction. Administrators can view these histograms in the compliance dashboard to track sensor health longitudinally.

Each RAGIS-RS unit participates in a decentralized swarm coordination protocol, enabling real-time symbolic behavior fusion and environmental event agreement across devices in the same physical site. Upon initialization, devices in the same jurisdictional cluster establish a shared symbolic memory state using a low-latency peer-to-peer handshake authenticated by site credentials and private DAG traversal signatures. This permits localized symbolic inference consistency, redundancy, and real-time coverage of complex spatial layouts.

The shared symbolic memory is an append-only log of anonymized symbolic glyphs, traversal tags, and redaction events recorded with nanosecond precision. Each glyph event includes: (i) symbolic class, (ii) confidence, (iii) timestamp, (iv) contributing modality set, and (v) local redaction index. This symbolic state is stored in a compressed DAG format using a memory-mapped trie optimized for high-frequency insertions and policy-constrained replay.

In a swarm configuration (e.g., 3-12 ceiling-mounted units in a retail space), devices coordinate behavior recognition zones to avoid redundancy or inference gaps. Each device continuously computes its coverage envelope—a polygonal area derived from optical, acoustic, and thermal field intersections—and publishes it to swarm memory. Overlapping areas are assigned primary/secondary status via dynamic consensus to balance load and fuse multi-angle symbolic observations.

Federated DAG orchestration allows site-level policies to span across devices. For example, a symbolic “customer aggression escalation” event may originate at Node A (gesture observed), but traverse into Node B's DAG (thermal increase, sound anomaly). Traversal is tracked using cross-node symbolic continuity IDs, ensuring that symbolic inference chains preserve causality and consent propagation, even when traversing hardware boundaries.

Symbolic policy DAGs are soft-forkable: each device stores a core DAG root and receives live forks representing regional rule updates or experimental traversal paths. DAG forks are cryptographically signed by compliance authorities or enterprise admins and loaded only after cross-node validation, maintaining synchronized logic across all swarm participants.

Fault detection within the swarm is handled via symbolic divergence monitoring. If two or more units report differing glyph classifications or DAG traversal outputs for the same event zone and timestamp range, the discrepancy is flagged and reviewed through a quorum consensus algorithm. The consensus selects the most trustworthy source based on past redaction integrity, sensor fidelity, and symbolic entropy.

To minimize bandwidth and ensure failover resilience, symbolic swarms use mesh gossip protocols with temporal prioritization. Critical consent-gated gestures (e.g., staff interaction with customer, redacted incidents) are propagated immediately. Less critical events (e.g., passive foot traffic, object detection) are delayed, compressed, and sent in bursts during low-inference cycles.

Every swarm maintains a local audit capsule containing symbolic glyph chains, traversal records, and redaction proof hashes for a rolling 72-hour period. These are synced to an encrypted cold storage node or compliance dashboard at scheduled intervals or upon trigger events (e.g., security incident, policy overwrite).

Symbolic consent arbitration is the protocol by which the system resolves whether behavioral data—especially involving staff or customers—is eligible for redaction, retention, or policy-based override. Each symbolic glyph is evaluated against a live consent capsule, a cryptographic envelope storing: (i) role-based permissions (e.g., staff vs. public), (ii) active duty or shift status, (iii) consent floor (minimum redaction), and (iv) override thresholds.

Consent capsules are loaded per individual and time window. For staff, capsules are auto-activated upon biometric or badge check-in; for public actors, a “store default” capsule is applied unless an override gesture or opt-in event (e.g., kiosk interaction) is detected. Each capsule is immutable for its session and cryptographically linked to its traversal outputs via Merkle hashes and DAG timecodes.

Arbitration occurs at the gesture classification level, not the raw frame level. When a sensitive gesture is detected (e.g., proximity breach, verbal escalation, object concealment), the system compares the current capsule's consent vector to the policy DAG node that would be triggered. If a redaction node exceeds the capsule's override threshold, the event is either obfuscated, substituted, or discarded.

Each arbitration decision produces a consent trace packet that logs: (i) the triggering symbolic glyph, (ii) contributing modalities, (iii) current capsule hash, (iv) DAG traversal path, and (v) the decision output (e.g., redact/retain/flag). These packets are bundled into a Consent Arbitration Ledger (CAL) and can be retrieved for audit or legal replay.

Staff interaction flows are governed by a role-trust propagation system. For example, a staff member engaging with a customer emits a role-escalation glyph that activates an extended capsule window where both parties are temporarily bound under the staff member's higher trust threshold. This allows safety or loss prevention scenarios to play out while preserving redaction accountability.

Customer-initiated gestures (e.g., waving down staff, proximity override via QR badge) can shift capsule weights dynamically. However, all changes are time-locked, tagged with the initiating actor's trust ID, and subject to DAG-based decay timers, ensuring that escalated consent does not persist longer than necessary.

Embedded redaction memory is a volatile symbolic buffer that tracks recent redacted gestures within a 90-second sliding window. This enables the system to maintain narrative cohesion for audit or compliance replay without storing full biometric input. Each redacted event is substituted in memory with a symbolic stand-in (e.g., “gesture redacted due to capsule threshold”), maintaining semantic flow.

Symbolic glyphs marked for redaction are immediately excluded from export logs, DAG state trails, and behavioral vector updates unless overridden by lawful intervention flags (e.g., subpoena mode). Redacted glyph hashes remain in system logs with null glyph values, ensuring proof of redaction without content leakage.

The RAGIS-RS system integrates with privacy-first insurance frameworks by providing real-time symbolic event streams, redaction logs, and consent-governed behavioral traces that are policy-compliant and privacy-enforcing. Unlike conventional surveillance exports (raw video, unredacted logs), the symbolic layer offers insurance providers semantically rich, legally admissible summaries without biometric exposure. Events like “slip-and-fall,” “object collision,” or “aggression escalation” are output as consent-attested symbolic capsules, eliminating the need for full-frame video disclosure.

Each symbolic capsule exported to an insurer includes: (i) event classification, (ii) consent signature proof, (iii) symbolic DAG traversal path, (iv) redaction flags and justifications, and (v) a hashed linkage to local device audit capsule. This enables providers to validate the claim context (e.g., “employee-client proximity breach”) while remaining compliant with GDPR, CCPA, and other regional laws. Policyholders can automate claim triggers without exposing personal identities.

The system supports liability automation pipelines by translating real-time symbolic glyph streams into trigger events for incident-based liability scoring. For example, if a “hazard object not removed” glyph persists for >60 seconds near a customer path and is followed by a “fall sequence” glyph chain, the system can trigger an auto-report to legal/compliance portals. Each such trigger includes redacted sensory context, DAG risk weight, and store policy code.

Liability scoring is computed on-device using a symbolic incident synthesis model, which calculates responsibility weight vectors across actors, staff, and infrastructure zones. The vectors are derived from behavioral temporal proximity, capsule duty states, and DAG compliance paths. This model enables proactive remediation—e.g., store layout warnings, staff feedback, or AI-generated liability reduction strategies (like gesture-based signage deployment).

Symbolic policy attestation is achieved through cryptographic proof-of-policy-execution. Each policy decision taken by the symbolic inference engine (e.g., “retain,” “redact,” “flag”) is logged into a tamper-proof ledger on-device and optionally pushed to a shared insurer ledger via API. These logs include: (i) the DAG node ID, (ii) redaction policy hash, (iii) capsule state vector, and (iv) real-time decision signature from the hardware Root-of-Trust.

Insurers can integrate this stream with smart contract-based premium adjustment engines, enabling dynamic insurance premiums based on verified behavior compliance. For instance, stores that demonstrate consistent redaction integrity, rapid hazard response, and low symbolic threat signatures can receive tiered premium reductions. This creates financial incentives for ethical AI deployment and consent-first surveillance.

In jurisdictions with active compliance watchdogs or collective bargaining unions, RAGIS-RS provides per-actor symbolic report bundles that show proof of non-surveillance. For example, a worker's weekly report may show: 0 unauthorized proximity captures, 3 consent-tagged incidents, and full symbolic glyph redaction compliance. These reports can be shared with labor attorneys or oversight boards in machine-readable format.

All insurance integrations are opt-in, cryptographically bound, and governed by signed DAGs from both enterprise legal teams and insurer policy templates. Redacted data is never transmitted. Symbolic capsules exported are digitally signed and timestamped, ensuring evidentiary integrity without video or audio exposure.

The RAGIS-RS system is built upon an ethics-first hardware and software stack designed to enforce non-invasive behavioral analytics, consent-aligned data flow, and immutable compliance trails. At its foundation is the symbolic ethics kernel, a tamper-proof runtime that intercepts all inference, redaction, and policy decisions, ensuring that no symbolic glyph or behavioral judgment occurs outside of cryptographically bounded DAG authority.

Each system boot is governed by a hardware-anchored trust attestation protocol. The device's secure enclave performs a Root-of-Trust verification sweep: it validates the symbolic kernel hash, the integrity of the policy DAG chain, the current firmware signature, and the timestamped consent capsule ledger. If any component fails signature verification, the system halts all inference, logs the error, and enters cryptographic lockdown mode until manual recovery by an authorized compliance administrator.

The symbolic ethics kernel cannot be bypassed by user commands, local admin overrides, or remote control. All input data streams—thermal, optical, skeletal, acoustic—must first pass through the ethics kernel's symbolic filtration engine, which assigns an initial confidence level, consent compatibility rating, and threat vector alignment. These parameters determine whether the signal is permitted to instantiate symbolic inference or is discarded upstream.

The tamper-proof compliance stack consists of four cryptographically signed ledgers:
1. Symbolic Event Ledger (SEL)—Logs every glyph generated with consent chain linkage and DAG node ID.
2. Consent Arbitration Ledger (CAL)—Stores redaction vs. retention decisions with capsule hash proofs.
3. Redaction Action Record (RAR)—Lists every invocation of symbolic masking, substitution, or removal.
4. DAG Traversal Record (DTR)—Reconstructs real-time symbolic execution paths and policy enforcement steps.
   Each ledger is stored in a write-once, append-only buffer encrypted with rotating public keys per jurisdiction, enabling off-site audit without internal data exposure.

The system's behavior-responsibility encoder introduces a semantic accountability layer that assigns each symbolic event a 5-vector responsibility matrix: (i) actor role, (ii) local environmental cause, (iii) policy noncompliance weight, (iv) consent chain alignment, and (v) system response classification (preventive/reactive/neutral). This matrix forms the basis of downstream liability, feedback loops, and insurance contract scoring.

Behavior responsibility is not assigned via biometric identity but through symbolic context trails. For example, “unauthorized access to staff-only zone” does not trigger face recognition, but rather aggregates environmental breach glyphs, path prediction trajectories, and DAG violation patterns. Only upon multivector match and policy threshold breach does the system escalate to redacted reporting or compliance dispatch.

At no point does the system produce biometric identifiers, facial reconstructions, or gait-based authentication. All symbols are derived from de-identified behavioral cues and fused into abstract semantic classes (e.g., “object concealment,” “verbal escalation,” “item drop”) that retain legal utility without identity tracking. These semantic glyphs are reusable across jurisdictions and retrainable as regulations evolve.

The ethics-first architecture also includes an independent audit port, which allows third-party inspection of symbolic DAGs, redaction logs, and consent capsule rules. This read-only port is physically separate from the inference pipeline and can be accessed via secure token by regulators, legal entities, or labor representation to verify that no unauthorized behavioral capture has occurred.

RAGIS-RS incorporates a jurisdictional DAG forensics engine, enabling the system to dynamically apply, audit, and reconstruct symbolic inference paths based on local legal constraints, privacy laws, and sector-specific policy overlays. Each jurisdiction—defined by GPS-bound zones or enterprise policy maps—has a cryptographically signed Policy DAG Fork, loaded during boot and updated weekly through compliance APIs.

These DAG forks include region-specific logic such as:
GDPR redaction priority enforcement (e.g., pre-consent discard for EU stores)
California Consumer Privacy Act (CCPA) behavior suppression thresholds
Treaty compliance overlays for labor-union enforced staff zones
National or provincial override exclusions (e.g., Québec biometric bans)
   Every symbolic traversal includes a Jurisdiction ID (JID) embedded in its hashchain, allowing legal auditors or multinational corporations to reconstruct policy flow per location and timestamp. This JID-tagged symbolic flow becomes the cornerstone of DAG forensics in cross-border compliance investigations.

When symbolic glyphs traverse across jurisdictional boundaries—such as during shared retail analytics across states or franchise networks—RAGIS-RS executes a policy descent negotiation, which resolves the symbolic execution stack according to the strictest overlapping policy. The resulting event glyph is encoded using the Symbolic Translation Stack (STS), ensuring consistency while preventing over-retention.

The STS is a cryptographically deterministic, invertible encoder that maps symbolic events from high-trust environments (e.g., no redaction needed) to mid-trust or redacted variants for lower-consent zones. For example, a “loitering object concealment” glyph in a Texas store might translate into “extended product interaction (redacted thermal data)” in a California location. This allows multinational compliance reports without duplicating hardware or software stacks.

DAG forensic replay is available via consent-segmented audit capsules, where regulators or legal teams can reconstruct symbolic flow through encrypted access grants. Only the symbolic class names, DAG node IDs, and decision vector hashes are shown; raw sensor data is never exposed. Replay sessions are protected by session-specific keypairs and expiration timers to prevent misuse.

In cross-border federated setups, a symbolic policy consensus ledger is maintained across RAGIS-RS fleets. This distributed ledger logs policy DAG forks, enforcement logs, capsule versions, and symbolic translation maps used across stores in the chain. Every update is signed by enterprise compliance leads and verified against sovereign redaction templates before synchronization.

If jurisdictional conflicts arise—such as symbolic retention permitted in the U.S. but forbidden in the EU—the system automatically falls back to the consent floor DAG, which strips down symbolic output to redacted class placeholders with traversal metadata only (e.g., “action observed: redacted,” “DAG node reached: suppressed”). These placeholder glyphs retain semantic flow without disclosing unauthorized inference.

Jurisdictional symbolic overlays are live-hotpatchable, allowing regional policy enforcement changes to propagate immediately across fleets. Policy DAG forks carry version numbers, expiration epochs, and diff signatures from base DAGs. This permits real-time forensic audits during incidents and ensures compliance across thousands of stores with minimal latency.

RAGIS-RS implements on-device synthetic data generation to continuously validate symbolic DAG traversal accuracy, redaction logic fidelity, and consent-chain enforcement without using real human data. Each unit contains a generative symbolic behavior engine (GSBE) capable of producing multimodal sensor emulations across thousands of pre-validated gesture archetypes, thermal patterns, acoustic bursts, and movement sequences.

The synthetic data pipeline operates within a sandboxed inference container, distinct from real-time device inference. It generates randomized symbolic glyphs based on DAG coverage targets and region-specific behavior libraries. This allows the device to simulate:
Edge-case gesture combinations
Redaction timing under overload
Consent override conflict resolution
DAG node contention arbitration
   This continuous symbolic testing ensures compliance even before real-world edge cases occur.

Every synthetic sequence is time-seeded and tagged with a non-exportable sim_flag, guaranteeing no false audit attribution. These simulations are embedded into symbolic logs for internal confidence tracking but excluded from export capsules, CAL, or insurer integrations.

RAGIS-RS also includes an anomaly rehydration engine, which takes redacted symbolic glyphs—where full context was suppressed—and reconstructs synthetic approximations of the possible original scenario using surrounding glyphs, zone metadata, and capsule thresholds. This allows regulators or store admins to visualize redacted events as plausible symbolic reconstructions without violating consent boundaries.

The rehydration engine uses:
Time-adjacent glyph continuity prediction
Consent capsule reverse simulation
DAG path interpolation using past traversal entropy
   This enables security personnel to reason about high-risk events (e.g., “redacted thermal spike+object concealment”) without needing biometric footage or illegal sensor retrieval.

Symbolic infrastructure testing is also extended to:
DAG fork consistency validation (against regulatory templates)
Consent arbitration stress-testing (burst-mode capsule switching)
Glyph suppression latency timing (to meet real-time compliance SLA)
   All tests are logged in the Symbolic Regression Test Record (SRTR), which is available for third-party audits under read-only token permissions.

To simulate real-world sensor faults, RAGIS-RS includes a sensor dropout emulator that triggers synthetic inference under degraded inputs—e.g., occluded thermal input, acoustic fuzz, IR reflection surge—allowing the symbolic ethics kernel to validate fallback behaviors such as class downgrading, gesture substitution, or redaction hard-fail locks.

Testing infrastructure runs on a background schedule that avoids interfering with live inference or swarm synchronization. Simulation events are assigned null capsule hashes to maintain separation from active DAG traversals, and symbolic entropy is recalculated after each test run to ensure symbolic glyph classes remain statistically valid.

RAGIS-RS includes a real-time semantic risk forecasting engine, which continuously evaluates the symbolic glyph stream to predict potential loss, liability, or escalation events before they manifest. Each incoming glyph—e.g., “thermal proximity spike,” “customer-employee dispute gesture,” “object concealment pattern”—is scored using a dynamic symbolic threat probability vector, trained on historical consent-tagged DAG traversals.

These vectors are input into a temporal DAG window, a moving frame of 3-12 seconds depending on store density and zone type. The window aggregates risk weightings across modalities (visual, acoustic, thermal, skeletal), allowing the system to detect:
Pre-escalation sequences
Repeated failure to intervene
Environmental hazard buildup
Gesture ambiguity clusters
   Forecast outputs are stored in a Symbolic Threat Ledger (STL), which flags zones, actors, or patterns likely to cause incident-class events within 20-90 seconds of lead time.

For staff, a behavioral feedback module converts symbolic glyph trails into role-adjusted training outputs. If a worker repeatedly engages in high-risk interaction types—e.g., inconsistent proximity boundaries, prolonged unacknowledged gestures, failure to intervene glyphs—the system compiles weekly symbolic snapshots tagged with behavior scores and capsule mismatch highlights. These reports remain redacted and are shareable with supervisors or union reps.

The symbolic feedback is never expressed as biometric judgments but rather gesture-class and interaction-flow analysis. For instance, “Gesture Class 8.1 (hand wave proximity escalation)→unresolved” may appear in a heatmap that visualizes role-response gaps without exposing individuals. The system can suggest symbolic intervention retraining modules tailored to gesture entropy trends.

Gesture-pattern entropy tracking allows RAGIS-RS to monitor the diversity, predictability, and anomalousness of symbolic input per zone, actor, and hour. High-entropy patterns—e.g., unusual item placements, sporadic movement glyphs, heat signature irregularity—trigger a symbolic anomaly state, useful for both loss prevention and real-time compliance review.

Entropy profiles are stored as per-zone DAG glyph entropy maps, which compress thousands of event traces into temporal statistical capsules. These can be used to:
Tune real-time sensitivity (e.g., reduce false positives in quiet hours)
Adapt DAG traversal thresholds dynamically
Create feedback loops between store layout and symbolic complexity

RAGIS-RS allows risk dashboards to be configured per store, franchise, or regional cluster. Managers can view real-time symbolic glyph flows, entropy scores, consent capsule activation rates, and DAG node heatmaps—without ever viewing live video or raw biometric inputs. This preserves compliance while enabling performance and safety optimization.

All semantic forecasting operates on-device, within the secure enclave, with optional encrypted summary transmission to cloud dashboards. Forecasts are rekeyed hourly, consent logs are bundled per 15-minute segments, and no historical biometric inputs are retained beyond policy-defined DAG windows.

The RAGIS-RS system leverages multimodal sensor calibration routines to harmonize inputs from thermal, visual, acoustic, and skeletal sources into a cohesive symbolic representation. Calibration occurs both during device installation and dynamically during live operation, ensuring that sensor drift, lighting variance, occlusions, and environmental interference do not compromise the symbolic DAG traversal accuracy.

Each modality is equipped with a self-check loop, where known gesture seeds or environmental test signals are injected and compared against expected glyph outputs. For example:
Thermal sensors run idle-body dispersion profiles
Acoustic sensors emit band-limited calibration pings
Visual feeds use edge-case boundary motion detection
Skeletal models validate limb vector closure rates
   Failures or inconsistencies trigger symbolic input suppression and error logging into the Symbolic Regression Test Record (SRTR).

Once calibrated, RAGIS-RS uses a symbolic class fusion protocol, where multiple sensor inputs are fused to produce a single coherent glyph. A hand movement detected visually, thermally, and skeletally is not treated as three events but rather as a fused Symbol Class 3.4 (e.g., “intentional extended arm movement with object”). Confidence weighting is applied per sensor, adjusted dynamically based on current environmental entropy.

Sensor fusion is executed within the DAG Vector Learning Core (DVLC), a learning model embedded in the symbolic ethics kernel. The DVLC:
Learns symbolic output alignment over time
Adapts to per-store behavior profiles
Reweights symbolic class probabilities as environmental entropy changes
Detects when sensor dropout requires fallback to partial-class estimation

This symbolic fusion ensures robustness in:
Occluded scenarios (e.g., customer blocking a camera)
Edge-of-frame gesture detection
Multisensor ambiguity (e.g., overlapping voices or gestures)
Degraded lighting or thermal conditions

RAGIS-RS supports symbolic class uncertainty representation by attaching a class confidence score and modality contribution breakdown to every glyph. This score determines DAG traversal depth and redaction aggressiveness. For instance, a low-confidence “concealment” glyph may be retained at lower DAG depth with stricter redaction policy applied.

When multiple plausible symbolic glyphs emerge (e.g., between “drop” and “throw”), the system forks the DAG and stores both as parallel symbolic paths, weighted by likelihood. These forks allow downstream modules like risk forecasting or liability scoring to maintain probabilistic inference without biasing outcomes.

Periodic entropy rebalancing ensures that overrepresented gesture patterns do not overfit symbolic DAG traversal paths. The DVLC prunes low-entropy glyph redundancies and highlights underrepresented classes for feedback inclusion or synthetic data injection.

RAGIS-RS integrates a Hardware Security Module (HSM) stack into every edge unit, ensuring cryptographic root-of-trust, tamper-resilience, and supply chain authenticity from manufacturing to field deployment. The HSM is embedded into the symbolic inference board and handles all certificate verification, capsule signing, and policy DAG sealing processes.

Upon power-up, the HSM initiates a Secure Boot Sequence, verifying:
The firmware signature using a fused manufacturer public key
The Symbolic Kernel hash against the compliance root
The Consent Capsule Ledger with real-time freshness attestations
The DAG Fork Version Map for the current jurisdiction
   If any component fails, the device halts inference and enters Cryptographic Lockdown Mode, logging the event locally and to the Symbolic Fault Ledger (SFL).

RAGIS-RS includes a multi-tier physical tamper detection array:
Pressure switches embedded in the casing detect opening attempts
Accelerometers trigger when excessive shock or tilt is applied
Voltage fluctuation monitors track unauthorized power bypass
Thermal sensors flag desoldering or micro-probing heat spikes

When tampering is detected, the system triggers a zero-state wipe:
Volatile memory is instantly erased
DAG paths, consent capsules, and glyph buffers are cryptographically shredded
The HSM disables all inference circuits until re-provisioned at factory
   This ensures no data exfiltration or backdoor access during theft, repurposing, or nation-state attacks.

All devices are issued with Hardware Provenance Certificates, containing:
Factory origin and batch ID
Component serial hashes (camera, CPU, thermal array)
Policy pre-load signature (e.g., EU vs. US compliance)
Deployment customer keypair
   These certificates are burned into the HSM and allow any fleet administrator to verify a device's origin and policy integrity without booting the inference pipeline.

RAGIS-RS hardware is traceable through the Symbolic Supply Ledger (SSL), a distributed cryptographic ledger that records:
Manufacturing events (assembly timestamp, operator ID)
Shipping custody chain (logistics firm, GPS checkpoint hash)
On-site pairing event (first DAG load, location lock)
   Each update is signed and hashed, allowing regulators or corporations to trace the entire hardware lifecycle down to the individual policy modules deployed per unit.

To prevent counterfeit or gray-market clones, the system supports Post-Deployment Fingerprinting. Each unit generates a Symbolic Behavior Fingerprint (SBF) within its first 48 hours—based on environmental gesture entropy, ambient noise spectra, and unique location capsule patterns. This fingerprint is impossible to spoof and can be checked remotely via audit API.

Customers (e.g., national retailers or government entities) can register custom Compliance Key Shards, split between their fleet key and manufacturer key. Only dual-signature boot approval unlocks the symbolic pipeline, ensuring no single entity (not even the manufacturer) can unilaterally hijack inference post-deployment.

RAGIS-RS is engineered to adapt intelligently to diverse retail environments, from compact convenience stores to sprawling department chains, using zone-specific symbolic overlays and auto-generated DAG subgraphs. Upon installation, each unit performs an Environmental Semantic Scan (ESS), identifying spatial zones (checkout, aisles, entrances, employee areas) using LIDAR depth mapping, acoustic profiling, and thermal pattern signatures.

This environmental scan is converted into a Zone DAG, a topological symbolic map of the store's behavioral expectations. For example:
Aisles emphasize loitering vs. browsing distinction
Checkout areas prioritize interaction glyphs
Entrances emphasize flow prediction and threshold anomaly detection
Staff zones embed stricter consent gating and gesture detection layers
   Zone DAGs allow symbolic inference to be context-aware and automatically enforce relevant redaction thresholds, event weightings, and consent capsule activation schedules.

In loss prevention workflows, RAGIS-RS eliminates the need for facial recognition or gait-based tracking. Instead, it relies on symbolic behavior chains (e.g., “hand hover→shelf touch→concealment glyph→exit vector”) with no biometric identity. Each behavior chain is:
Tagged with risk class and entropy weight
Matched against historic event DAGs
Recorded in a non-identifying Symbolic Anomaly Capsule (SAC)
   Only upon repeated anomaly classes in a zone does the system escalate to real-time intervention signaling or silent anomaly flagging for review.

RAGIS-RS enables staff augmentation, not surveillance. For example, if thermal data shows prolonged customer-object engagement near a high-theft item, a symbolic suggestion glyph is issued to nearby staff via secure AR overlay or tablet alert (e.g., “Customer may need assistance, Zone A4”). This framing avoids accusatory semantics while reducing loss rates and improving service perception.

The system supports symbolic insurance billing triggers, where incident-class glyphs (e.g., “slip-and-fall risk,” “product instability gesture,” “verbal escalation”) are automatically bundled with zone metadata and DAG traversal records to generate symbolic incident capsules. These are:
Time-sealed and signed by the symbolic ethics kernel
Biometric-free but zone-verified
Auditable by insurers for liability adjudication

For instance, in a slip-and-fall scenario, RAGIS-RS generates:
Symbol Class 9.2 (slip signature)
Thermal event trail before and after impact
Consent capsule for whether signage or cleanup was symbolically acknowledged
DAG path from hazard observation to incident glyph, enabling full symbolic reconstruction

Insurance providers may integrate with RAGIS-RS through Redacted Symbolic Claim APIs, allowing structured submission of incident capsules with DAG validation hashes, without transmitting raw data. These APIs streamline claim approvals while demonstrating regulatory compliance and legal defensibility.

Retailers using RAGIS-RS can auto-generate Compliance Risk Scores per zone, hour, and event class, which correlate directly with insurer discounts, OSHA training triggers, or workforce optimization. These scores are derived from symbolic event rates, entropy consistency, consent mismatch deltas, and DAG fault traversals.

RAGIS-RS supports a swarm deployment architecture that enables multiple devices within a store—or across a regional franchise cluster—to act as a coordinated symbolic inference mesh. Each unit runs an instance of the symbolic ethics kernel but can dynamically share non-biometric symbolic glyphs, DAG path summaries, and consent capsule entropy metadata across the swarm to create a Zone-Synchronized Symbolic Fabric (ZSSF).

Swarm coordination begins with Edge-to-Edge Symbolic Propagation, a protocol where:
Symbolic glyphs generated by one device are broadcast via secure LAN tunnels to adjacent units
Devices use spatial topology maps and thermal occlusion vectors to determine glyph relevance
Consent hashes, DAG node IDs, and entropy deltas are tagged and cross-validated
Redundant glyphs are deduplicated in real-time using symbolic overlap estimation
   This enables full-scene symbolic coverage across aisles, blind zones, or multi-level structures without requiring panoramic sensors on each device.

Swarm members use a lightweight DAG stitching protocol, where concurrent symbolic traversals from different perspectives are merged into Consensus DAG Snapshots every 500 ms. This shared symbolic reality allows high-fidelity symbolic prediction, even in situations where gesture fragments or occlusions would impair a single-unit inference.

To preserve privacy, only redacted symbolic class IDs, entropy weightings, DAG node timestamps, and capsule masks are transmitted between units. Raw thermal, audio, or visual sensor feeds are never shared. All inter-device messages are E2E encrypted and signed using keys provisioned during installation and refreshed hourly.

RAGIS-RS also allows Cross-Store Cognition Transfer, where symbolic learning patterns—e.g., rare gesture sequences, entropy edge-cases, or anomalous behavior flows—are encoded into DAG pattern capsules and uploaded (opt-in) to a central cloud symbolic ledger. These capsules are then diffed, verified, and transmitted to other stores in the chain.

For example, if a store in New York experiences a novel theft behavior involving a jacket concealment gesture plus thermal masking, that behavior's symbolic path can be transmitted as a compressed DAG Glyph Capsule, allowing stores in California or Europe to preemptively tune their DAG traversal thresholds or issue predictive entropy triggers.

Stores can subscribe to behavioral diffusion filters by:
Zone type (checkout, refrigerated aisle, cosmetics)
Region (urban U.S., rural Canada, EU privacy zones)
Risk class (escalation risk, insurance loss class, union override triggers)
   Only verified, consent-compliant symbolic capsules are included, and each receiving store's symbolic kernel retrains itself locally using synthetic reinforcement, never biometric replays.

This architecture enables symbolic collective cognition across vast retail networks without violating local data laws or requiring cloud-based biometric processing. Each RAGIS-RS unit thus becomes a node in a sovereign symbolic mesh capable of privacy-safe, collective behavioral foresight.

RAGIS-RS enforces symbolic contract compliance through real-time DAG execution paths that evaluate staff-customer interactions, event class glyphs, and environmental context against preloaded policy contracts. These contracts are encoded as Policy DAG Modules (PDMs), which define acceptable gesture sequences, consent triggers, override boundaries, and redaction rules.

When an interaction unfolds—such as a verbal escalation between staff and customer—RAGIS-RS captures:
Gesture glyphs with entropy trails
Proximity vector weights
Thermal emotion spectrum deltas
Symbolic context (checkout, aisle, backroom, etc.)
   This data is passed through the PDM interpreter, which runs a symbolic compliance check in real-time. If the path deviates from the policy contract (e.g., staff intervention before consent nod or failure to disengage post-verbal escalation), a Symbolic Breach Flag (SBF) is raised and logged.

RAGIS-RS enables autonomous redaction arbitration without requiring legal review or data destruction. The symbolic kernel classifies each glyph or gesture class as:
Consent-valid
Context-permissible
Policy-exempt
Policy-violation
   These classifications are hashed, timestamped, and submitted to the Redaction Ledger, where auditors or legal entities can replay symbolic states without ever accessing raw footage or biometrics.

For instance, if an employee is accused of discrimination, the RAGIS-RS system can generate a symbolic path showing:
Interaction start time (symbolic initiation event)
Verbal intensity curve (from acoustic emotion tensor)
Consent capsule mismatch (failure to match escalation glyph to disengagement)
DAG verdict: Policy path→invalid at node 18, Clause 3.7.2
   This allows human auditors to verify behavioral truth without violating privacy.

Each incident or behavior interaction is scored using a Consent Risk Vector (CRV):
Based on entropy volatility
Symbolic gesture ambiguity
Consent-capsule desynchronization
Historical context within zone class
   The CRV is then mapped to a Policy Violation Matrix (PVM), producing:
A redaction directive (keep, blur, destroy)
An audit risk level (low, medium, high)
A DAG reconstruction trigger (for incident replay)

For employers, this creates a quantifiable symbolic liability framework, reducing exposure to litigation while maintaining transparency, training, and policy enforcement.

RAGIS-RS is architected with an ultra-low-latency symbolic inference pipeline that operates entirely on-device via a high-efficiency neuromorphic edge chip stack, optimized for symbolic DAG traversal rather than traditional convolutional inference. The architecture enables sub-20 ms glyph resolution, even during peak gesture load.

The Symbolic Inference Engine (SIE) comprises:
A sparse symbolic matrix multiplier for DAG path propagation
A multi-channel entropy vector buffer
A predicate encoder for real-time class fusion
A micro-DAG prefetcher tuned for gesture temporal alignment
   This engine avoids conventional deep-layer inference in favor of rule-modulated symbolic projections, dramatically reducing inference depth and power consumption.

To ensure symbolic latency reduction, RAGIS-RS uses:
DAG pre-warming: probable next gestures are precompiled into register-cached traversal branches.
Entropy pruning: high-confidence, low-ambiguity glyphs bypass intermediate fusion steps.
Zone-aware compression: lower-traffic or peripheral zones run on collapsed symbolic kernels.

The system maintains latency under threshold via adaptive symbolic budget allocation. Each zone or interaction class is assigned a symbolic compute budget based on historical entropy volatility. If a zone enters anomaly state, compute is dynamically reallocated to ensure priority DAG path traversal.

RAGIS-RS includes failover resilience protocols in case of edge inference degradation, sensor dropout, or symbolic kernel freeze:
Each unit contains a redundant DAG traversal core with cold-swap logic triggered by symbolic stall timers.
Devices log their last successful DAG snapshot and capsule ledger state every 500 ms to encrypted NVMe modules.
In case of power loss, units reboot into “symbolic safe mode,” reloading their latest verified DAG and resuming inference within 250 ms.

For broader resiliency, the system supports mesh failover, where symbolic state deltas and DAG path diffs are shared with adjacent units. A neighboring RAGIS-RS node can reconstruct the failed unit's recent symbolic scene via cross-propagated capsules and gesture extrapolation, maintaining continuity in both coverage and symbolic compliance logging.

The inference firmware uses a stateless symbolic loop model, preventing long-tail memory leaks or temporal drift errors common in stateful ML pipelines. DAG paths are evicted based on symbolic time horizon, consent capsule duration, and entropy degradation rather than arbitrary frame count or memory pressure.

Firmware updates, including symbolic kernel patches or DAG protocol versioning, are handled via dual-image OTA updates, cryptographically signed and verified against both manufacturer and customer keys. Failover boot logic ensures rollback to last working symbolic inference version if patch verification fails.

RAGIS-RS includes a jurisdictional symbolic overlay (JSO) mechanism that allows the symbolic ethics kernel to adapt its inference policies, DAG path filters, consent capsule behavior, and redaction logic in compliance with local, national, and international regulatory frameworks.

At installation, the RAGIS-RS system downloads or is preloaded with a jurisdictional compliance DAG, defined by:
Legislative boundaries (e.g., GDPR, CCPA, LGPD)
Cultural gesture variance datasets (e.g., nodding≠consent in all cultures)
Language-specific audio cues
Symbolic privacy overlays (e.g., automatic suppression in private dwell zones)
   Each symbolic overlay is signed by a Regulatory Root Authority and version-locked to legal interpretations as of issuance date. The system supports updates with change diff capsules for audit continuity.

To manage multilingual gesture adaptation, RAGIS-RS fuses skeletal motion models with linguistic DAG triggers. For example:
A Spanish-speaking customer raising a hand while saying “perdón” triggers a consent capsule under different path logic than “excuse me” in English.
Thermal stress detection is weighted differently based on typical linguistic escalation paths in Japanese vs. German zones.

Language overlays are loaded into a Multilingual Gesture Matrix (MGM), where gestures are tagged by:
Region of origin
Consent trigger vs. deferral gesture
Escalation weight mapping
Cultural gesture collision (e.g., thumbs-up may trigger approval in one zone and insult in another)
   This matrix dynamically tunes the symbolic parser to ensure semantic accuracy and legal defensibility.

RAGIS-RS supports International Compliance Profiles (ICP) for chains that operate across jurisdictions. Each unit auto-selects the appropriate symbolic overlay at boot, using:
GPS/geofencing
Wi-Fi regulatory hints
Customer-specified deployment region
   Profiles determine:
Consent retention window
DAG event storage horizon
Redaction thresholds
Glyph class categorization boundaries

If a unit crosses regions (e.g., mobile deployment or hardware reallocation), it triggers a Symbolic Recontextualization Routine, which:
Halts inference
Clears region-specific DAG paths and overlays
Reloads new jurisdictional capsule stack
Reinitializes consent capsule framing structures
   This ensures no cross-jurisdictional leakage of symbolic assumptions or DAG fragments.

For example, a retail kiosk moved from California (CCPA zone) to Paris (GDPR zone) will:
Switch from opt-out to opt-in capsule logic
Enforce full DAG redaction after 48 hours instead of 30 days
Suppress behavioral glyphs that touch inferred emotion layers without explicit consent

All jurisdictional transitions are logged in the Symbolic Region Ledger, which maintains a cryptographic timeline of every symbolic overlay applied to each unit, along with regulator ID, timestamp, and DAG diff hash.

Each interaction within RAGIS-RS is framed by a Consent Capsule, a cryptographically bound container that logs the symbolic context, DAG traversal path, and consent state associated with a specific event (e.g., object handling, staff interaction, hazard observation). Consent capsules are central to ensuring legal, ethical, and behavioral traceability without exposing biometric data.

A Consent Capsule includes:
Capsule ID (CID) derived from SHA-3 hash of symbolic DAG path+gesture entropy seed
Time window (start/end)
Zone identifier (e.g., checkout, aisle 2, storage room)
Consent vector: auto-initiated, explicit, deferred, or revoked
Capsule entropy score (probabilistic clarity of consent sequence)
Embedded redaction policy: auto-expire, archive, escalate

Consent capsules are managed by a Capsule Lifecycle Controller (CLC), which oversees:
Initialization: upon DAG path match to known consent-triggering sequence
Validation: cross-verification against policy DAG (e.g., explicit nod, gesture chain)
Commit: capsule signature sealing with device HSM
Expiration: based on jurisdiction, entropy decay, or policy override

Capsule expiration behavior is policy-bound and varies by jurisdiction:
In GDPR zones, auto-expiration is triggered after 48 hours unless elevated by a flagged glyph
In CCPA, expiration defaults to 30 days unless opted-in by customer interaction (e.g., loyalty kiosk)
In enterprise installations, capsule durations may map to union labor contracts, insurance clauses, or surveillance agreements

RAGIS-RS supports Symbolic Capsule Mutation, where a capsule can be:
Split (forked) upon divergence in DAG path (e.g., staff enters mid-interaction)
Merged with sibling capsule (e.g., multiple customers handling same item)
Escalated to Incident Capsule (IC) if a policy boundary or anomaly glyph is encountered

Capsules are immutably logged in the Symbolic Capsule Ledger (SCL), with only redacted symbolic class hashes, timestamp, and entropy score exposed to auditors. Raw gesture data is never persisted beyond capsule expiration unless sealed as part of an audit path.

For integrity, each capsule is sealed with a DAG Signature, a unique cryptographic binding of:
Full symbolic path traversed (encoded as node sequence and transition rules)
Consent validation logic ID
Capsule type and redaction clause
Device serial and jurisdiction overlay version

DAG signatures are generated by the device's symbolic ethics kernel, then double-signed by the onboard HSM and a compliance verification engine. These signatures are stored in a Merkle tree ledger, allowing audit systems to verify capsule provenance without accessing underlying data.

In case of dispute or regulatory audit, capsules are reconstructed into Symbolic Consent Trails, readable only via policy-matched replay environments. These allow lawyers, auditors, or compliance officers to step through symbolic scenes, gesture-by-gesture, without needing video playback or voice logs.

RAGIS-RS leverages multimodal symbolic sensor fusion to generate rich, real-time, context-specific symbolic representations of human behavior without relying on identifiable biometric features. Each device continuously ingests and fuses input from the following channels:
360° optical lens array (visual gesture vectors)
Directional microphone matrix (acoustic tone+semantic intent)
Thermal IR matrix (emotion patterning+spatial focus)
Vibration and pressure nodes (step detection, slip events)
Time-of-flight depth sensors (spatial grounding+reach prediction)

These modalities are unified into a Dynamic Entropy Tensor (DET), which encodes per-frame uncertainty, directional ambiguity, and interaction zone risk. The DET acts as the root structure for every glyph interpretation, ensuring that confidence-weighted paths are chosen through the symbolic DAG kernel.

DET is built as a 4D tensor with dimensions:
Modality (vision, thermal, audio, depth, etc.)
Spatial vector (x, y, z position of observed actor)
Temporal window (rolling 2.5 s buffer, with 500 ms sliding updates)
Symbolic entropy weight (confidence in current state path)
   Each glyph is generated by Modal Path Intersection (MPI), which looks for temporal alignment between DET slices across modalities. For example:
A thermal peak (emotion spike) aligning with acoustic escalation and depth displacement will produce a high-entropy “escalation glyph.”
A subtle skeletal pause+repeated object handling+downward gaze may generate a “hesitation glyph” tagged with zone class (e.g., high-theft shelf).

RAGIS-RS uses a Redaction-Aware Glyph Parser (RAGP), a rule engine that determines whether a glyph is:
Redactable (e.g., inferred stress)
Exempt (e.g., customer purchase)
Enforceable (e.g., union-defined motion boundary breach)
   This parsing layer references the jurisdictional overlay and local store policy DAGs in real time, ensuring that no redaction-exempt glyph is allowed into audit logs or live staff interaction flows unless explicitly policy-sanctioned.

RAGP also enables inline symbolic suppression, where glyphs that fall below entropy threshold or breach privacy weightings are:
Flagged but not recorded
Masked in DAG traversal
Replaced with zero-weight symbolic stubs for continuity
   This system ensures legal and ethical compliance while maintaining full symbolic path traceability and DAG continuity for future incident reconstruction.

To increase speed and accuracy, RAGIS-RS applies temporal fusion compression, where gesture sequences that repeat across time slices are coalesced into single macro-glyphs with confidence multipliers and context persistence flags. These allow the symbolic kernel to operate on compressed inference units, dramatically reducing memory footprint and processing latency.

The Symbolic Ethics Kernel (SEK) in RAGIS-RS is the core computational engine that governs behavioral interpretation, consent enforcement, symbolic DAG integrity, and policy-bound redaction. Unlike traditional inference models, SEK is rule-executing, context-evolving, and sovereign-compliant by design.

The kernel is built on a Symbolic Execution Graph, where:
Each node represents an ethical decision point (e.g., inferred stress vs. observer obligation)
Edges are weighted by policy logic, entropy bias, and historical context
DAG paths reflect evolving symbolic memory across a scene or chain of events
   SEK can adapt its ethical traversal paths based on jurisdiction overlays, union contracts, or custom policy DAGs without requiring retraining or firmware redeployment.

DAG Integrity Validation is handled by a triple-check architecture:
Traversal Hash Sealing: Every decision path is hashed using Keccak-256 and written to the local immutable ledger per event cycle.
Symbolic Logic Consistency: At each node, SEK checks that observed behavior does not violate DAG execution consistency—i.e., if a policy requires disengagement after two verbal escalations, a third escalation triggers a symbolic fault flag.
Redaction Compliance Trace: SEK verifies that redaction tags (auto, contextual, exempt) match output storage and consent ledger commits.

In live deployment, the SEK continuously evaluates Symbolic Redaction Risk Zones (SRRZs), which are DAG subgraphs marked as sensitive or policy-protected. For example:
In a pharmacy checkout, gesture paths involving medical items+repeated gaze+thermal drop will invoke a redaction-priority flag.
In employee breakrooms, acoustic signals tagged with private speech patterns are masked at the DAG node level before ever entering capsule recording.

On-device treaty compliance is enforced via the Embedded Treaty Kernel (ETK), a policy-locked submodule of SEK that hardcodes sovereign law into symbolic DAG traversal. Treaties can encode:
Surveillance labor thresholds (max tracking hours per worker per shift)
Consent override pathways (manual staff override permitted by gesture+voice)
Symbolic memory timeouts (auto-forgetting behaviors not tagged for compliance storage)

Treaties are loaded as Policy Sealing Modules, signed by jurisdictional authorities, labor unions, or corporate governance boards. Once loaded, ETK will:
Invalidate DAG paths that would violate treaty terms
Trigger symbolic stop signals on offending behavior
Mask or void consent capsules born from treaty-infringing sequences

The symbolic ethics kernel can thus operate across heterogeneous environments (retail, healthcare, warehouse) with perfect DAG verifiability, consent traceability, and sovereign policy observance—without exporting a single frame of biometric data.

RAGIS-RS encodes staff interaction protocols directly into its symbolic ethics kernel, ensuring that employee behaviors are not only monitored but contextually parsed, consent-audited, and treaty-compliant. These protocols are defined as Union-Aware DAG Paths (UADPs)—symbolic sequences representing valid and invalid interaction types based on labor agreements, behavioral norms, and legal precedent.

Each UADP is constructed from:
Gesture-glyph class sets (e.g., open-hand gesture+directional body pivot)
Verbal intent signature (from prosody, stress markers, phrase types)
Interaction zone type (e.g., checkout, warehouse, public, private)
Consent framing: explicit, deferred, rejected
   For example, a staff member approaching a customer in a high-sensitivity zone (e.g., pharmacy aisle) must execute an intent-to-assist glyph chain within three seconds of proximity engagement; failure to do so triggers a consent breach flag.

RAGIS-RS recognizes Labor-Treaty-DAG Mismatch Events (LTDMEs), including:
Initiating interaction outside of permitted time windows (e.g., during mandated break periods)
Physical gesture proximity violations (defined by union contract DAG clause)
Escalated tone without prior verbal consent capsule
   When an LTDME occurs, the ethics kernel raises a Treaty Compliance Signal (TCS), which:
Suspends symbolic logging for the interaction (to avoid self-incrimination or illegal surveillance)
Issues a symbolic stop to the staff member via LED or audio cue
Notifies the store DAG monitor node for review and ledger update

Consent-driven escalation suppression is a key feature of RAGIS-RS. It prevents retail staff from compounding high-risk customer interactions by embedding symbolic behavior governors into DAG paths. These governors:
Block policy-violating gestures from being interpreted as “defensive”
Prevent verbal escalation from generating enforcement capsules if consent was not explicitly logged
Automatically disengage DAG path traversal and trigger symbolic freeze-state when legal thresholds are reached (e.g., temperature+volume+posture match pre-escalation model)

Staff behavioral profiles are symbolically modeled using Interaction DAG Histories (IDHs). These are non-identifiable logs that track:
Frequency and type of customer interaction
Escalation curve over time
Policy breach glyph types
Consent capsule match rate
   IDHs are used for training, liability protection, and DAG-based performance reviews without ever exposing video or audio.

Supervisors can access DAG Summary Nodes for each employee, which provide:
Symbolic interaction map (heat zones of activity)
Risk glyph frequency (e.g., aggression class per 100 interactions)
Compliance trail (ratio of governed DAG paths vs. flagged)
   This creates a privacy-compliant, consent-aware feedback system where behavior is auditable symbolically, not biometrically.

RAGIS-RS includes a dedicated Symbolic Anomaly Detection Engine (SADE) that operates independently of facial, biometric, or individually-identifiable input. Instead, it identifies behavioral divergence via gesture-entropy analysis, symbolic drift detection, and DAG structure variance, providing actionable alerts without violating privacy boundaries.

Each behavior stream processed by the Symbolic Ethics Kernel is mirrored into an Entropy Signature Map (ESM), which monitors:
Variation from baseline gesture velocity vectors
Skeletal configuration shift frequency
Prosodic (acoustic) tone instability
Thermal signature volatility
Path divergence from expected DAG sequence
   The ESM computes a composite Symbolic Divergence Score (SDS) for each time window, which is then checked against zone-specific anomaly thresholds.

RAGIS-RS defines Anomaly Classes as symbolic states that:
Exceed entropy threshold for given zone
Diverge from typical DAG path by more than n transitions
Include predicate nodes marked for incident escalation (e.g., weapon shape, sprinting gesture, repetitive agitation glyph)
   Each anomaly class is tagged with:
Severity index (low to critical)
Contextual zone weight (e.g., stockroom vs. cashier lane)
Consent trace modifier (was this initiated or witnessed?)
Redaction score (public vs. private zone, bystander presence)

To mitigate false positives, SADE uses DAG Drift Correction (DDC). When gesture sequences deviate but entropy is low (e.g., pacing customer near checkout), DDC:
Realigns the path to the nearest policy-legal glyph cluster
Applies a time-decay tolerance model
Annotates the path as soft anomaly for retrospective audit

High-confidence anomalies trigger:
A Symbolic Alert Capsule (SAC) containing gesture-glyph class, entropy vector, symbolic zone, and DAG hash path
Immediate symbolic stop signals to staff via on-device visual/auditory cue
Optional escalation to local enforcement channel if DAG path overlaps with policy-encoded critical threat sequence

RAGIS-RS units network anomaly glyphs through the Swarm Symbolic Mesh (SSM), allowing nearby devices to:
Increase anomaly sensitivity
Share DAG segment weights
Preload predictive paths for regional coherence
   This provides scene-wide anomaly anticipation without needing centralized processing or biometric correlation.

In compliance-focused regions (e.g., EU), the anomaly engine adheres to Redaction-Aware Mode, ensuring that:
No video or audio is recorded
Only symbolic class hashes and entropy indexes are preserved
Consent state at anomaly time determines retention logic

RAGIS-RS integrates real-time symbolic overlays via local display interfaces to provide immediate, privacy-compliant visual feedback to both customers and staff. These overlays use symbolic glyphs—never raw camera footage—to indicate behavioral zones, active consent states, and safety cues in retail environments.

The Customer Overlay Display Module (CODM) presents abstracted symbolic feedback on wall-mounted or ceiling-embedded displays, including:
Color-coded consent zones: green (active consent), yellow (pending consent), red (restricted)
Glyph icons for staff approach, product interaction, or policy boundaries
Anomaly glyph flashes (symbolic, non-text) when DAG paths indicate a safety or compliance concern
   Displays dynamically adjust based on symbolic state transitions, never displaying identifiable images, names, or speech content. Symbolic rendering is updated every 250 ms from the ethics kernel.

CODM operates using Symbolic Scene Rendering (SSR), which projects a top-down schematic of the retail area using:
Glyph tags for actors (e.g., STAFF-1, VISITOR-3)
Real-time DAG overlays to illustrate predicted gesture paths
Consent ring visualizations around actors when relevant (e.g., staff entering high-sensitivity zones)

Staff-facing overlays are governed by the Privacy-Compliant Feedback Interface (PCFI). This interface is tablet-or HUD-delivered and shows:
Consent capsule status for nearby actors
Predicted DAG path trajectory (3 s window)
Redaction zone alerts (e.g., storage, restroom, pharmacy areas)
Symbolic stop cues if an interaction violates labor treaty DAG rules
   PCFI ensures that all guidance is abstract, behavior-class-based, and compliant with union and jurisdictional rules—no identity tagging, face display, or biometric estimation is used.

RAGIS-RS supports Redacted Retail Visualization Interfaces (RRVI) for managers and third-party auditors. These are symbolic-only replay tools that:
Reconstruct behavioral scenes as DAG walkthroughs using anonymized glyphs
Display symbolic timelines, consent capsule histories, and anomaly triggers
Allow filtering by policy clause, zone, time, or symbolic interaction class
   RRVIs can be securely streamed via an enclave or loaded locally onto encrypted tablets, with access keys tied to cryptographic replay certificates.

### Example Scenario

A customer in aisle 4 hesitates over a product.
   CODM renders a “deliberation glyph”
   PCFI shows a staff member an amber consent ring (no interaction until approach is initiated by customer)
   RRVI logs the event as a non-recorded capsule with symbolic entropy below review threshold
This system provides fully observable, legally defensible, and privacy-aligned surveillance—purely via symbolic abstraction.

RAGIS-RS includes a Symbolic Training Dataset Architecture (STDA) designed to generate, refine, and simulate symbolic behavioral patterns entirely without biometric datasets, ensuring full compliance with privacy, labor, and international data sovereignty regulations.

The STDA is composed of:
Synthetic Glyph Generator (SGG)—produces gesture, acoustic, and thermal interaction sequences based on symbolic primitives (e.g., reach, hesitate, engage, retreat)
Policy-Informed DAG Compiler (PIDC)—injects treaty logic, consent constraints, and zone-specific overrides into DAG structures
Entropy Curve Emulator (ECE)—maps probabilistic variations into gesture streams to model behavioral ambiguity and escalation patterns
Scenario Block Generator (SBG)—assembles training capsules across modular retail scenarios (e.g., theft attempt, refund request, emergency evacuation)
   These components allow RAGIS-RS to simulate millions of legally-compliant interaction DAGs without recording real-world individuals or relying on legacy surveillance data.

Each synthetic training DAG includes:
Time-coded symbolic paths with tagged glyph classes
Capsule metadata (zone, consent state, treaty overlay)
Symbolic entropy envelope (for tuning risk class boundaries)
Behavior outcome class (e.g., resolved, escalated, redacted)

The system supports Regulator-Signed Simulation Capsules (RSSCs), which are DAG-certified behavioral sequences approved by:
Union compliance boards
Privacy regulators (e.g., GDPR panels)
Retail risk auditors
Insurance underwriters
   Each RSSC is cryptographically signed and loaded onto RAGIS-RS devices as a trusted behavioral baseline. This means that ethical decisions, escalation models, and symbolic path branching are provably derived from regulator-approved models—not from biased, biometric, or proprietary surveillance systems.

RAGIS-RS training architecture includes a Symbolic DAG Augmentation Layer, which permutes input capsules to generate:
Environmental variants (e.g., lighting, sound obstruction)
Cultural gesture overlays (e.g., bow vs. nod)
Consent pattern inversions (explicit→deferred→revoked)
Escalation arc variants for stress testing
   This architecture allows global deployments of RAGIS-RS to retain jurisdictional nuance, cultural compliance, and legal auditability—all without ever touching video, names, or faces.

RAGIS-RS includes a sovereign-grade Enclave-Based Replay System (EBRS), enabling real-time and historical reconstruction of symbolic events without exposing raw data, video, or personal identifiers. These enclaves operate as sealed execution environments with controlled ingress and zero external export capability, designed for incident arbitration, policy review, and insurance/legal traceability.

Each symbolic interaction or anomaly is recorded as a Symbolic Capsule, which contains:
Encrypted DAG path from interaction onset to resolution
Consent state snapshots at each critical node
Zone context (store area, treaty overlays, redaction flags)
Entropy envelope and symbolic annotations
Capsule ledger signature with timestamp and policy hash
   These capsules can be reviewed by authorized personnel using the EBRS interface—displayed solely as symbolic glyph flows with hashed metadata—maintaining strict compliance with all biometric and visual redaction laws.

The EBRS supports Symbolic Incident Arbitration (SIA), where multiple capsules can be:
Cross-analyzed for path similarity (to detect bias or systemic risk)
Compared to regulator-approved simulation DAGs (RSSCs)
Evaluated against labor-treaty compliance curves
Flagged for redaction, suppression, or escalation review
   Each arbitration event is cryptographically notarized and policy-stamped, generating a tamper-evident record trail for third-party evaluators (e.g., insurance agents, union reps, legal reviewers).

RAGIS-RS integrates a Zero-Knowledge Policy Audit (ZKPA) layer, allowing external regulators to validate:
That escalation decisions align with signed treaties
That redacted content was appropriately suppressed
That employee behavior data was not exported or misused
   ZKPA uses symbolic proofs generated from the ethics kernel's DAG traversal logs. These include:
Entropy-matching ZKPs (e.g., proving an escalation met threshold without revealing thermal/audio data)
Consent DAG consistency proofs (e.g., demonstrating that no post-hoc consent overrides occurred)
Redaction boundary compliance (e.g., showing a glyph class was suppressed without exposing what it was)

ZKPA protocols are signed by the device enclave, validated via remote attestation with a regulator key, and can be performed live or periodically. These audits provide sovereign-grade assurances of ethical operation, symbolic compliance, and privacy preservation—without any footage, faces, or speech recordings.

EBRS+ZKPA together establish a closed-loop, legally defensible symbolic surveillance model that:
Prevents data exploitation
Protects worker and customer rights
Enables third-party accountability
Unlocks insurance/legal adoption at scale

RAGIS-RS implements a robust Blockchain Anchoring Framework (BAF) to secure symbolic capsules, preserve redaction integrity, and enable external verification of behavioral compliance across all deployed environments. This framework ensures that no symbolic event, consent override, or redaction tag can be tampered with or falsified post-capture.

Every Symbolic Capsule Ledger Entry (SCLE) is:
Signed by the local enclave at capture time
Hashed using SHA-3 (Keccak-256)
Embedded with metadata (capsule class, entropy band, treaty ID, zone ID, DAG hashpath)
Anchored to a permissioned distributed ledger (e.g., Hyperledger, zkRollup Ethereum sidechain) on a rolling interval (e.g., every 15 minutes)
   Each entry is grouped into a Consent Event Bundle (CEB) with a Merkle root representing the snapshot state of the entire symbolic ethics kernel. The Merkle root is immutably stored on-chain.

RAGIS-RS enforces Redaction Notarization Chains (RNCs) to track symbolic glyph suppression. Each time a DAG node or path is:
Masked (due to redaction zone)
Censored (due to treaty logic)
Erased (post-symbolic TTL expiry)
   . . . an RNC entry is created with:
Redaction reason code (e.g., employee break zone, private item interaction)
Consent token trace
DAG location hash
Temporal window
Notarization timestamp
   These RNCs allow external auditors to verify what was redacted, why, and when—without needing to know what the redacted glyph actually was.

In the event of symbolic data corruption, replay failure, or anomaly misclassification, RAGIS-RS executes a DAG Fault Remediation Workflow (DFRW). This includes:
Isolating the corrupted capsule and DAG segment
Triggering enclave-local fault logging with symbolic path trace
Notifying supervisory nodes in the swarm for quorum-based override
Rebuilding the symbolic DAG using neighboring capsule history, treaty context, and anomaly regression
   Remediation logs are themselves hashed and committed to the ledger, creating an immutable record of system integrity and fault recovery.

Supervisory interfaces provide:
Visualization of DAG fault graphs
Signed redaction trails
Capsule ledger diffs
Regulator-readable replay streams (symbolic only, no biometric data)
   This system delivers legal-grade compliance, multi-tenant accountability, and data-forensic traceability without ever violating privacy rights or recording visual identities.

RAGIS-RS is implemented as a fully modular privacy-by-design edge device, consisting of stackable hardware components optimized for sensor fusion, symbolic processing, and zone-specific physical constraints. The hardware architecture is designed for installation in retail ceilings, kiosks, or mobile retail pods, with no requirement for external compute or video storage.

The core physical components of the RAGIS-RS unit include:
360° Panoramic Optical Unit
   Ultra-wide FOV fish-eye lens array
   No facial recognition, no RGB video output; only skeletal+blob contours
   Onboard symbolic gesture abstraction at the image signal processor (ISP) level
Thermal-Acoustic Sensor Matrix
   Long-range directional microphones for prosodic intent classification
   Multi-zone passive infrared (PIR) and thermal anomaly detection
   Vibration transducers embedded in mounting chassis to detect environmental triggers (slamming, crashes, stomping)
Symbolic Sensor Fusion Kernel (SSFK)
   FPGA or neuromorphic core optimized for gesture glyph synthesis
   On-chip privacy-state registers enforce in-sensor redaction of disallowed zones (e.g., restrooms, employee breakrooms)
   Built-in consent token interpreter; no event is stored unless consent capsule present
Modular Consent Display Ring (MCDR)
   Circular LED+LCD hybrid display surrounding lens perimeter
   Dynamically renders symbolic status glyphs (consent granted, treaty in effect, anomaly detected, etc.)
   Allows real-time feedback to staff and customers in zone

RAGIS-RS units include Privacy Hardware Root of Consent (PHRoC) chips, which:
Seal all sensor logs unless consent or treaty flags are active
Block transmission or replay unless enclave-approved capsule exists
Enforce redaction at the physical signal level (e.g., drop gesture glyphs from privacy zones)

Physical form factor is designed to match standard 6″, 8″, or 12″ ceiling tile dimensions, with passive thermal venting, silent operation, and optional solar-harvesting skin. Devices communicate via encrypted mesh (LoRa or private 5G) to avoid dependency on store Wi-Fi.

Installation modes include:
Fixed ceiling orb (standard retail surveillance replacement)
Wall-mount wide-angle variant (narrow aisles or corridors)
Portable “privacy pod” for mobile staff conflict arbitration
Checkout-dock variant with enhanced thermal gradient analysis

RAGIS-RS deployment occurs through a multi-phase consent-anchored installation protocol ensuring jurisdictional, technical, and ethical compliance before activation. Each unit remains inert until it receives:
A signed zone-level Treaty Initialization Package (TIP)
A verified mesh identity beacon from its deployment cluster
A jurisdictional firmware signature bundle (JFSB) containing encoded consent schemas, redaction overlays, and symbolic region classifiers
   Only upon validation of these three signatures will the device initialize its sensor stack and begin symbolic cognition operations.

Devices are automatically synchronized via SwarmMesh-C (Consentualized Swarm Mesh Controller), a local, encrypted, consent-token-routed mesh network protocol that:
Auto-discovers nearby RAGIS-RS nodes upon power
Performs zone handshake (e.g., checkout, restroom-adjacent, office entrance)
Propagates real-time treaty overlays to ensure contextual ethics matching across the deployment field
Allocates symbolic behavior classifiers to specific nodes (e.g., high-fidelity aggression detection near entrance, staff consent arbitration in employee-only zones)

Firmware updates are governed by a Symbolic Firmware Chain (SFC). Each firmware bundle includes:
Symbolic behavior policy DAGs
Consent and redaction classifiers
Treaty-bound region classifiers (e.g., EU GDPR-compliant symbolic redaction modules)
Device-zone-specific behavior sets
Symbolic compression/decompression routines
   Each update is signed at three levels: by the central ethics kernel, the zone's consent steward, and the regulator's firmware audit office. All signatures are verified before device update proceeds. Firmware includes TTL and update-window scheduling to match labor regulation windows (e.g., overnight refresh only).

Firmware updates are transmitted via zero-export multicast from a local gateway node or portable firmware key, ensuring no external API, cloud, or internet path is required. All devices conduct self-signed manifest checks, treaty compatibility audits, and DAG class sanity checks before live-switching symbol classes.

Emergency protocol exists for symbolic lockdown: A consent steward or union delegate may trigger Zone Redaction Panic (ZRP) mode. This:
Freezes active capsules
Redacts all human-identifying symbols
Broadcasts a Treaty Override packet
Commits symbolic record to immutable hash block
   No external actor can override this locally unless pre-consented within the treaty DAG.

RAGIS-RS introduces a Symbolic Data Monetization Model (SDMM) that enables retailers to generate revenue or unlock cost offsets from symbolic behavioral data without ever storing or exposing biometrics, video, or speech content.

### Symbolic Capsule Licensing (SCL)

Symbolic interaction capsules (DAGs with consent and policy overlays) are packaged into anonymized capsule bundles. These bundles are leased or licensed to:
Retail analytics firms (for layout optimization, queue modeling)
Insurance providers (for incident risk forecasting)
Urban planning entities (for zone heatmap synthesis)
AI ethics labs (for training behavior-class-only AGI models)
   Each lease is tokenized with a jurisdictional use key, limiting it to the region or treaty class in which the symbolic data was originally captured.

### Retail Insurance Integration

RAGIS-RS qualifies retailers for insurance premium reductions due to:
Fully auditable, redacted safety incident logs
Zero biometric liability footprint
Signed symbolic capsules for dispute defense
Proven escalation DAG models compliant with labor and workplace safety codes
   Insurers integrate symbolic capsule bundles into risk models for slip/fall, theft, harassment, or emergency evacuation—with ZKPA-verified claims serving as legal-grade evidence.

### Jurisdictional Data Lease Engines (JDLE)

RAGIS-RS includes a leasing engine that allows retailers to:
Lease symbolic capsule bundles to researchers or government entities under limited, encrypted terms
Set rulesets for symbolic class export (e.g., permit “intent hesitations” but redact “aggression arc” capsules)
Receive passive revenue for high-value symbolic insight classes (e.g., crowd-flow DAGs during peak hours)

Each leased dataset is:
Capsule-level redacted
Treaty-compressed
DAG-templated
Audit-signed with retail consent steward and zone registrar
   This enables stores to transform traditionally liability-prone surveillance data into jurisdictionally compliant symbolic capital, without ever handling PII.

RAGIS-RS uses a Symbolic Capsule Lifecycle (SCL) protocol that governs how symbolic behavioral interactions are captured, retained, decayed, and eventually erased. Unlike traditional surveillance systems that archive data indefinitely, this system applies entropy modeling and decay logic to ensure data self-destruction based on utility, compliance, and ethical relevance.

### Symbolic Capsule Lifecycle Stages

Each symbolic capsule undergoes five defined lifecycle phases:
1. Capture—Glyph DAG recorded in enclave with timestamp, treaty context, and consent snapshot.
2. Activation—Capsule is made queryable for analysis, arbitration, or audit for a defined TTL window.
3. Dormancy—Capsule enters latent state pending no incident or recall trigger.
4. Entropy Degradation—Symbolic entropy curve is computed based on relevance, zone, policy shifts, and access logs.
5. Redacted Purge—Capsule is stripped of glyphs, consent tags, and ledger trace, then decays cryptographically.

Entropy scores are calculated via multi-factor symbolic models that factor:
Zone sensitivity (e.g., staff-only, checkout, restroom-adjacent)
Consent volatility (explicit, deferred, revoked, expired)
Incident linkage (referenced in arbitration or ignored)
Treaty timeline adjustments (expired jurisdictional overlays)
   Capsules with high entropy scores and no consent recall enter accelerated decay.

### TTL-Based Memory Compression

Capsules have a configurable TTL (time-to-live) policy defined at install per zone, often ranging from:
24 hours (for standard customer walkpaths)
7 days (for employee interactions)
30+ days (for union-covered arbitration trails)

After TTL expiry, capsules are:
Compressed to zone-level entropy summaries (no per-glyph details)
Tokenized as redacted entries
Ledger-hashed to ensure proof-of-deletion
   This allows storage-efficient symbolic memory that still permits aggregate analytics without PII exposure.

### Symbolic Data Ghosting & Treaty Recall

Treaty law may demand capsule resurrection under certain triggers (legal audit, insurance claim, etc.). RAGIS-RS handles this through:
Ghost Anchors—cryptographic null-pointers that preserve DAG hash without containing glyph payload
Rehydration Keys—signed treaty artifacts that reconstruct DAG shape and path entropy from recall cache (never from original glyph stream)

The architecture thus supports ethical memory lifecycles: symbolic cognition with ephemeral persistence, recall upon lawful trigger, and irreversible decay.

RAGIS-RS integrates a Closed-Loop Symbolic Coaching Interface (CLS-CI) to enable real-time staff feedback, adaptive behavioral modeling, and embedded ethical enforcement without surveillance, scoring, or punitive analytics. Instead, this system works through cooperative symbolic overlays that interpret employee-customer dynamics and guide improvements using embodied AGI principles.

### Real-Time Symbolic Agent Feedback

Each zone can be configured with a symbolic AI agent—either visual (LED glyphs on MCDR), auditory (earpiece cues), or haptic (vibration signals)—providing:
Gesture-based suggestions (e.g., “open stance”, “de-escalation hand motion”)
Ethical conflict detection alerts (e.g., tension spikes, withdrawal triggers)
Energy-awareness prompts (e.g., entropy nearing critical threshold)
   This feedback is encoded through symbolic glyphs—not text, not ratings—so employees are coached within a cognitive framework aligned with non-verbal intent.

No permanent logs of agent-staff interaction are stored. Feedback glyphs are ephemeral, consent-token triggered, and cleared from capsule memory within 60 seconds unless acknowledged.

### Embedded Consent-Tethered Agents

AI agents deployed in RAGIS-RS are zone-consent-tethered, meaning they activate only when:
Staff has opted in
The zone is governed by a treaty enabling agent assistance
Symbolic capsule type matches a “coachable” class (e.g., hesitation, misalignment, emotional mismatch)
   Agents operate strictly within symbolic cognition space, never accessing name, face, or audio content.

Staff may interact with these agents via:
Hand gestures (e.g., symbol for “repeat”, “mute”, or “escalate”)
Symbolic wearable taps (wristband or pendant with DAG-linked token)
Feedback suppression zones (walking into private treaty zone disables agent)

### Behavior Replay & Union-Ethics Layer

Supervisors, union representatives, or ethics stewards may review symbolic glyph flows during training to:
Reconstruct DAGs of difficult interactions
Observe gesture entropy mismatches (e.g., high-energy mismatch in low-consent zones)
Suggest alternative symbolic gestures
   These replays are redacted of biometric and audio data, timestamp-capsuled, and consent-token signed. All staff behavior review requires a treaty DAG trigger.

### Closed-Loop Benefits

This coaching system yields:
Real-time conflict de-escalation
Labor-compliant behavior support
Retail performance improvements without surveillance
Symbolic cognition feedback loops that boost AGI-aligned staff interaction

RAGIS-RS enables cross-location symbolic training through a federated, non-biometric knowledge transfer system known as the Federated Symbolic Cognition Exchange (FSCE). This architecture empowers multi-site retailers to continuously improve staff-customer interaction quality—without centralizing any video, audio, or identity data.

### Federated Symbolic Behavior Graphs

Each store node contributes locally learned Symbolic DAGs (S-DAGs) to a shared symbolic training ledger. These DAGs represent abstracted behavioral patterns such as:
Queue tension resolution
Assistance hesitation
Conflict escalation gestures
Consent-seeking body language

All S-DAGs are:
De-identified at the symbolic level (contain no ID, video, or audio)
Compressed into reusable behavior motifs (subgraph templates)
Signed with zone ID, policy class, and consent steward key
Appended to the global Symbolic Pattern Graph Pool (SPGP)

### Adaptive Zone-Specific Improvement

New or underperforming locations can subscribe to SPGP bundles tuned to their zone type:
Urban express checkout patterns
Suburban customer-service prioritization
Gas station staff-to-driver conflict diffusers
   The RAGIS-RS agent downloads these symbolic subgraph templates and merges them into its local cognition engine, forming a collective improvement corpus without privacy risk.

All federated learning is done via:
Encrypted symbolic subgraph exchange
Consent-flag-triggered synchronization
Treaty-class-matching to ensure jurisdictional relevance
On-device reinforcement based on performance and entropy feedback

### Performance Without Surveillance

This federated model yields:
AGI-aligned training across 1000s of locations
Measurable staff improvement (gesture entropy decrease, DAG flattening)
Global pattern detection (e.g., seasonal crowd dynamics, regional consent mismatches)
No centralized surveillance, no facial datasets, no employee scoring

RAGIS-RS includes a Consent-Governed Arbitration Mode (CGAM)—an emergency symbolic procedure designed for legal-grade incident replay, third-party intervention, and conflict resolution without ever exposing biometric or raw sensor data.

### Arbitration Trigger Protocol

Arbitration Mode may be triggered by:
A union representative or staff member via consent-tokened device
A treaty-defined override by a store steward
An external regulator with jurisdictional clearance
   Upon trigger:
All live capsules in the affected zone are sealed
Symbolic DAGs are snapshot-anchored with timestamp and entropy signature
Behavior class overlays are frozen in audit trail format
No further capture or classification occurs until arbitration is resolved

A Redacted Capsule Bundle (RCB) is then generated, containing:
Symbolic gesture paths only
Consent class tags
Entropy gradients
No video/audio, no skeletal IDs, no environmental noise stream
   This bundle is hashed, stored in tamper-proof symbolic memory, and mirrored to the local steward's device.

### Legal Witness Capsule (LWC)

A third-party observer (e.g., legal counsel, insurance investigator, or labor union) may request a Legal Witness Capsule, which:
Replays symbolic interaction DAGs with timestamped glyph flow
Visualizes behavior transitions (e.g., de-escalation→aggression→withdrawal)
Flags treaty violations or consent inconsistencies
Includes zero biometric or facial data
   This capsule is compliant with GDPR, CPRA, and Canadian PIPEDA frameworks, using predicate-only classification and treaty-compliant overlays.

### Post-Arbitration Capsule Finalization

Once arbitration concludes:
DAGs are either archived (if validated), redacted (if disputed), or erased (if misclassified)
All parties sign a Treaty Resolution Capsule (TRC), stored locally with hash-verified recall path
The arbitration record becomes immutable, retrievable only under future treaty clause triggers

CGAM ensures staff protection, ethical compliance, and legal-grade incident resolution—without violating privacy or enabling surveillance weaponization.

The RAGIS-RS system concludes with integrated Hardware Blueprint Specification, Thermal-Electric Footprint, and Compliance Interfaces, locking in the platform's eligibility for global rollout across regulated retail, public, and energy-sensitive spaces.

### Hardware Blueprint Overview

The RAGIS-RS node consists of the following components:
Ceiling-mounted Orb Sensor Array (COSA):
   360° omnidirectional fisheye lens
   Embedded ToF and thermal matrix
   Sonic/infrared perimeter tracking lattice
   Symbolic Redaction Kernel (SRK) chip on device
Modular Consent Display Ring (MCDR):
   E-ink LED ring signaling capture state
   Public consent signal glyphs+zone classification indicators
   Touch interface for manual override
Onboard Symbolic Execution Module (OSEM):
   FPGA/ASIC symbolic kernel
   DAG memory array with local TTL/entropy decay
   No biometric retention cache
Symbolic Ledger Port (SLP):
   Treaty-aligned microcontroller for capsule hashing
   Secure enclave for redacted arbitration bundles
   PKI-based lease token transmitter

### Thermal-Electric Footprint

Optimized for low-energy edge operation:
Max draw: 12 W (full symbolic processing mode)
Passive mode: <3 W (redaction idle state)
Operational temp range: −10° C. to +55° C.
Internal waste heat redirect loop toward SRK chip to maintain DAG integrity
   System includes fallback cold-start capacitor to ensure integrity capsule is flushed even during power interruptions.

### Compliance Interfaces and Closing Scope

The platform complies with:
GDPR, CPRA, PIPEDA—via full biometric redaction and symbolic abstraction
OSHA 29 CFR § 1904—incident logging and symbolic consent tracking
ISO/IEC 27001 and 27701—secure capsule storage and lease protocols
IEEE P7000 and P7016—AGI ethics design alignment and surveillance redaction

The RAGIS-RS may be modified to support:
School, transit, or hospital environments with alternate symbolic class sets
Voice-triggered consent override for accessibility
Multi-node symbolic federation within a sovereign corporate ledger
   The invention is not limited to the embodiments described, and it is intended that variations and equivalents will be included within the scope of the claims.

### BRIEF DESCRIPTION OF THE DRAWINGS

FIG. 1 is a system-level diagram of the RAGIS-RS node architecture, showing integration of symbolic execution kernel, sensor array, redaction engine, and consent-trigger overlay.

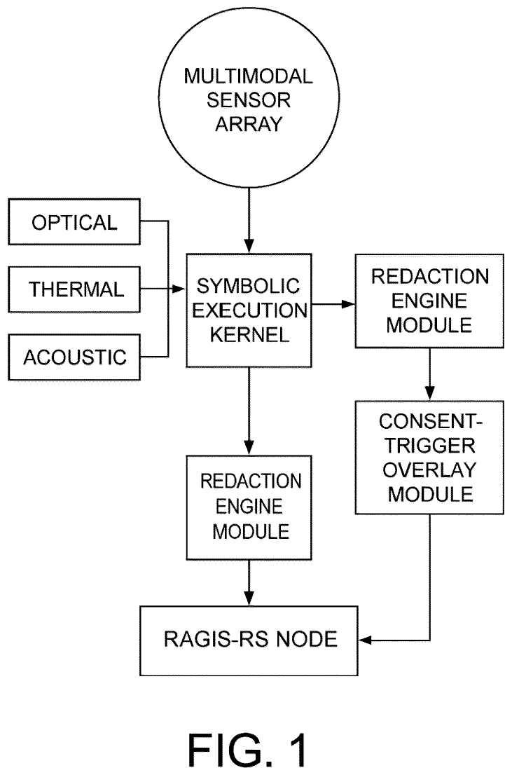

FIG. 2 is an exploded isometric view of the Orb Sensor Array (OSA), including optical, thermal, sonic, and ToF modules, along with onboard symbolic processing unit.

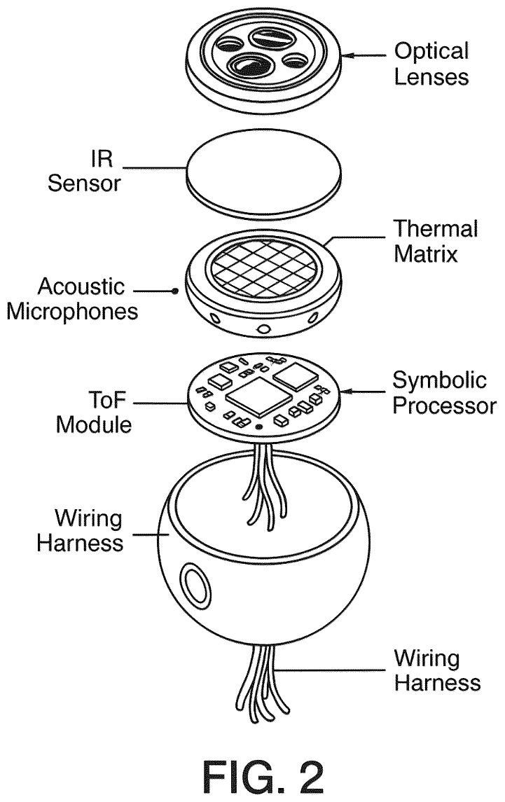

FIG. 3 is a process flow diagram illustrating capsule generation, classification into symbolic gesture DAGs, consent snapshotting, and ledger anchoring.

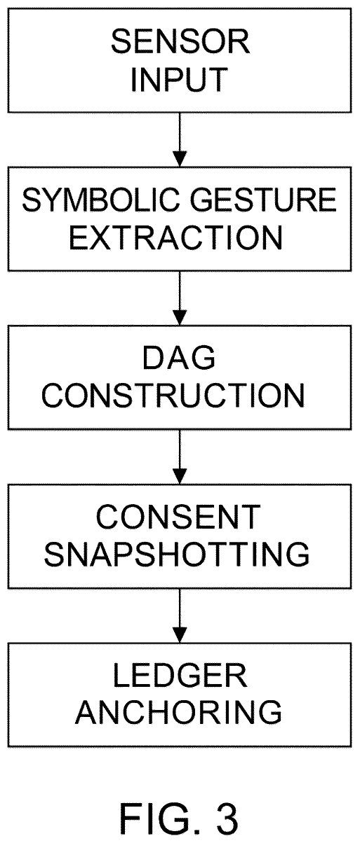

FIG. 4 is a glyph-class map of behavioral motifs, showing symbolic representations for approach, hesitation, consent-seeking, conflict, and retreat transitions.

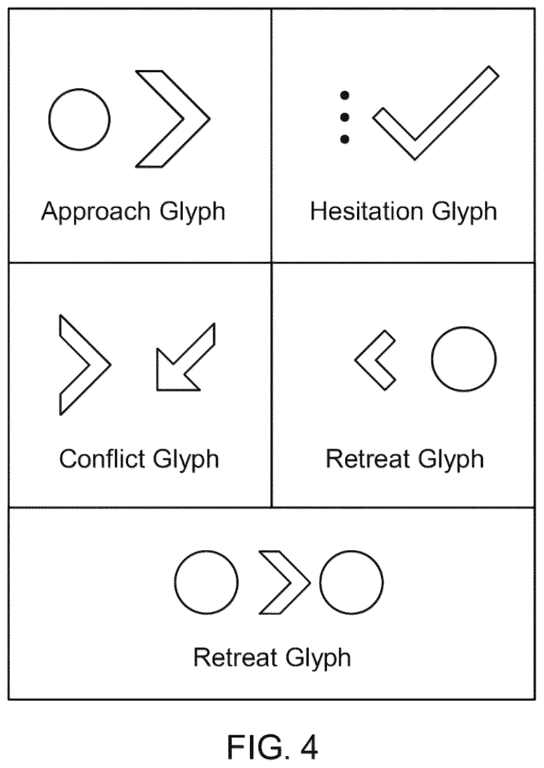

FIG. 5 is a zone-level overlay map showing policy-class segmentation across a retail layout, with consent-triggered capsule flow paths.

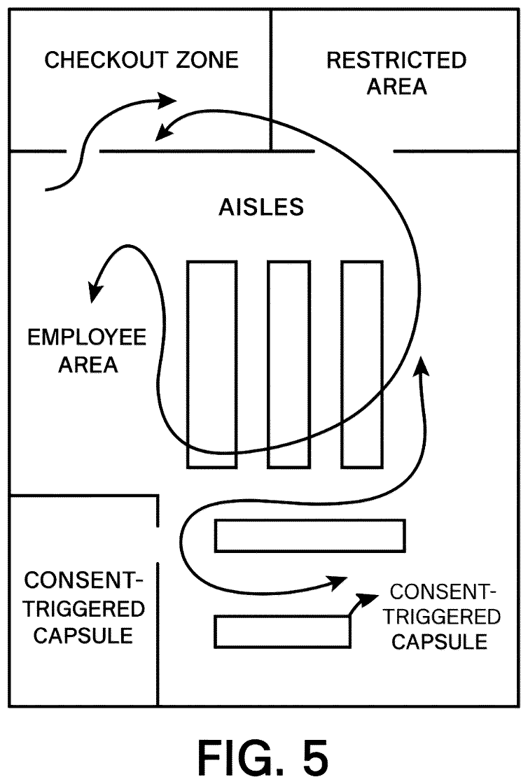

FIG. 6 is a symbolic capsule lifecycle diagram showing transitions from capture to activation, dormancy, entropy degradation, and redacted purge.

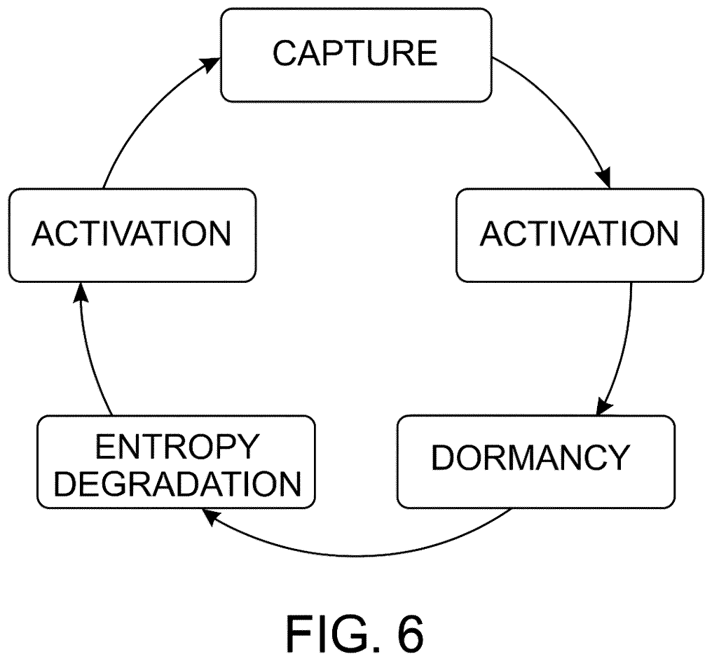

FIG. 7 is a DAG compression flowchart illustrating motif hashing, node bundling, and treaty-anchored capsule reduction.

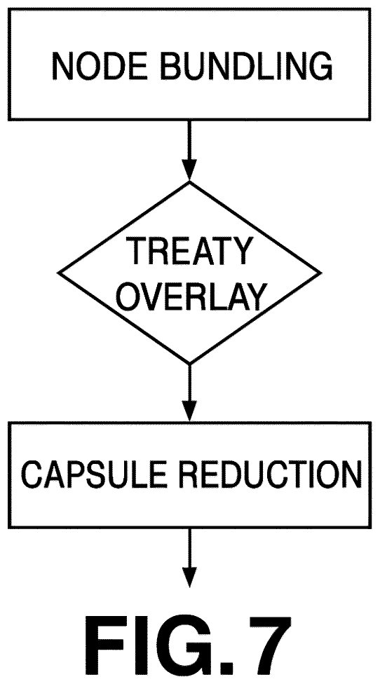

FIG. 8 is a hardware schematic of the Modular Consent Display Ring (MCDR), with embedded LED glyph display, haptic feedback coils, and override sensor.

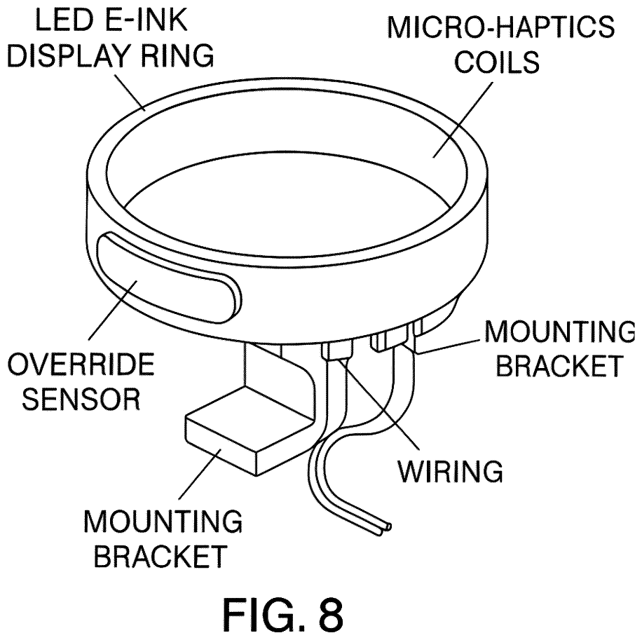

FIG. 9 is a visual representation of symbolic arbitration mode activation, showing real-time capsule freeze and redacted bundle generation.

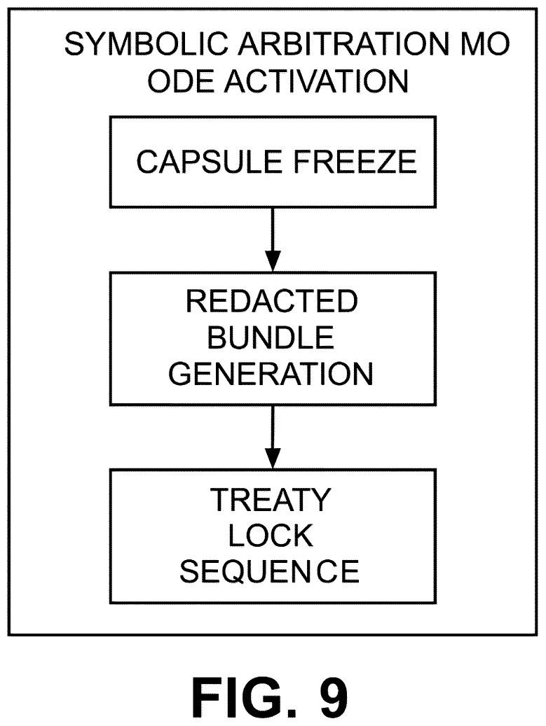

FIG. 10 is a symbolic agent interaction loop for live staff coaching, with gesture recognition, feedback glyph dispatch, and entropy scoring.

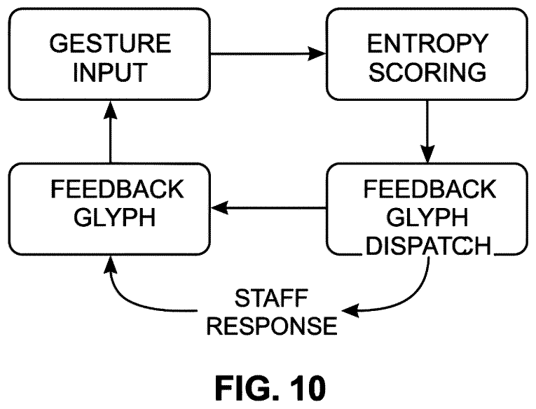

FIG. 11 is a flowchart of federated symbolic cognition exchange, illustrating DAG template ingestion, motif injection, and local reinforcement.

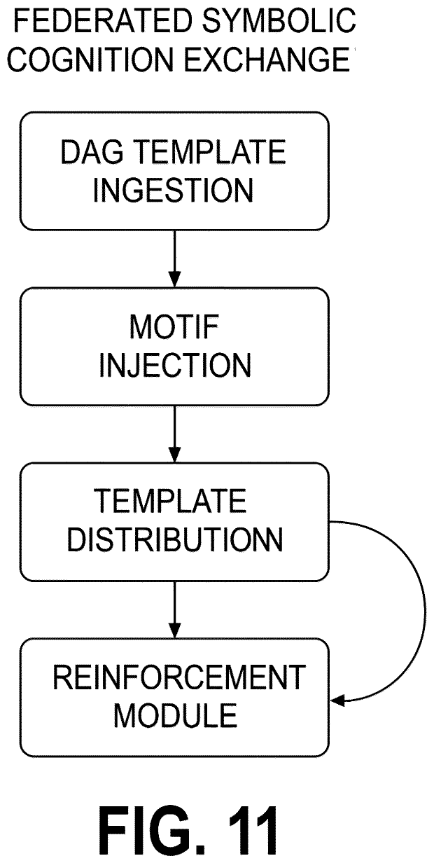

FIG. 12 is a diagram of symbolic pattern entropy, illustrating behavior gradient tracking, mismatch detection, and escalation class transitions.

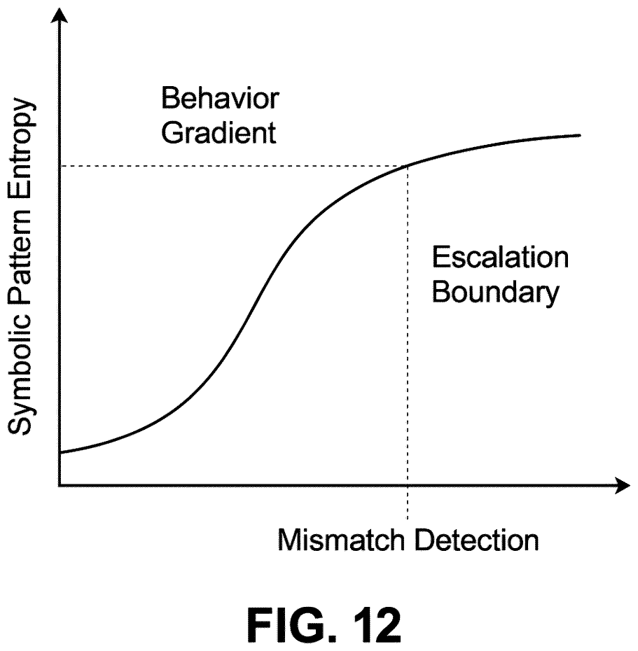

FIG. 13 is a consent-token arbitration ledger flow, detailing treaty-class override, capsule replay, and third-party witness channel.

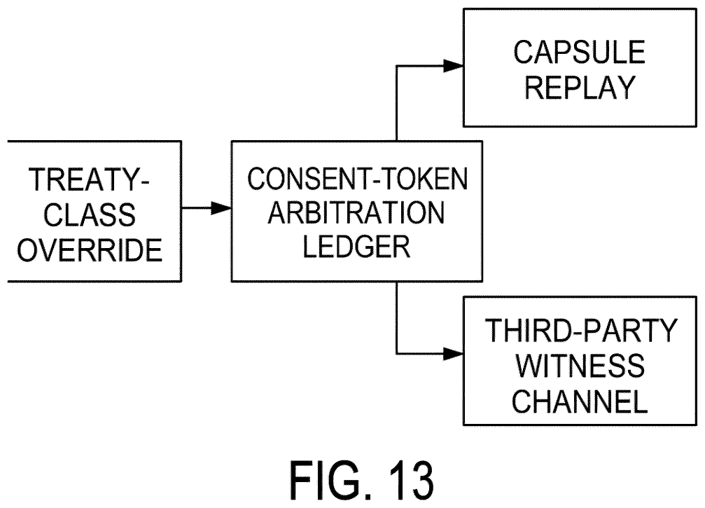

FIG. 14 is a top-down layout of sensor cone fields and capture null-zones for privacy preservation in sensitive zones.

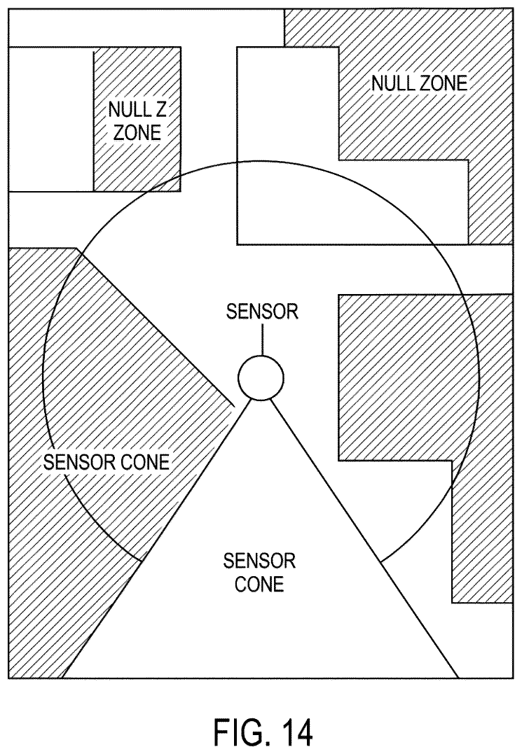

FIG. 15 is a heatmap visualization of symbolic entropy across staff-customer interactions, showing gesture smoothing and feedback convergence.

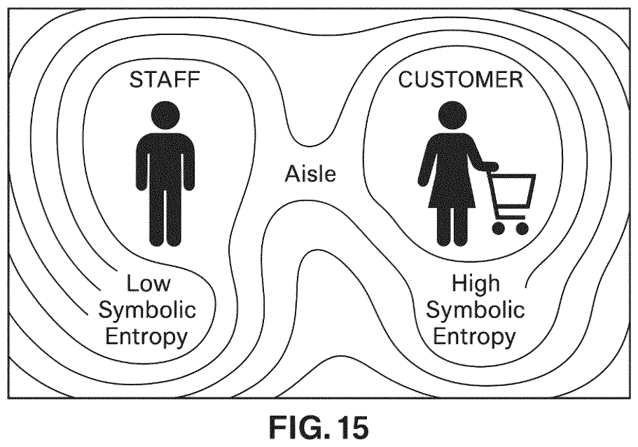

FIG. 16 is a failover diagram of capsule retention logic during power loss, showing capacitor-backed memory flush and hash persistence.

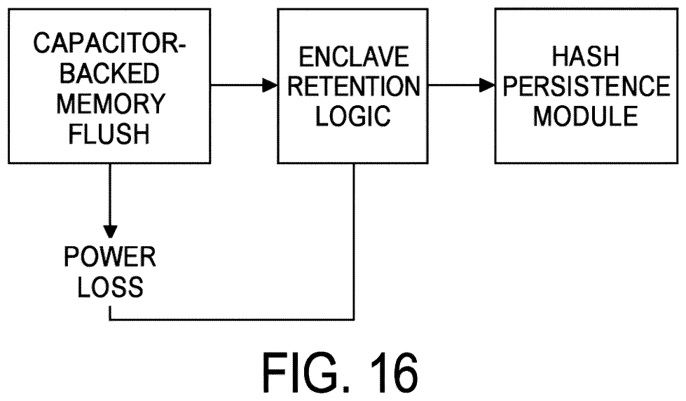

FIG. 17 is a DAG topology map showing recursive motif nesting, capsule branch resolution, and policy-overlay constraints.

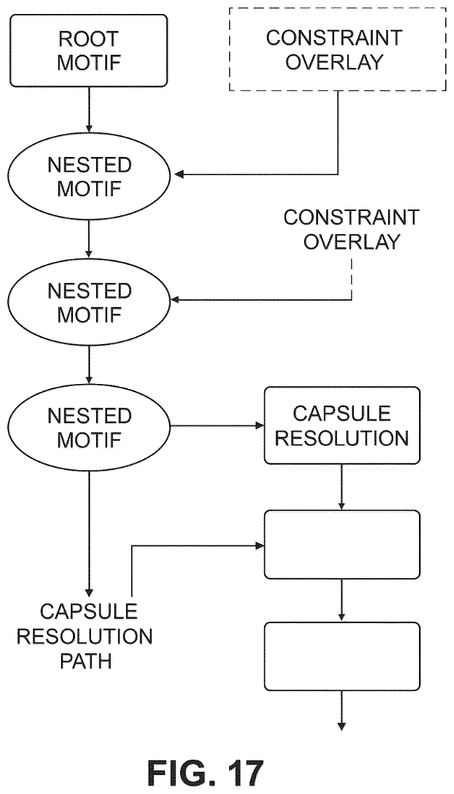

FIG. 18 is a symbolic lease lifecycle for capsule monetization, showing bundle generation, treaty tagging, and revenue path.

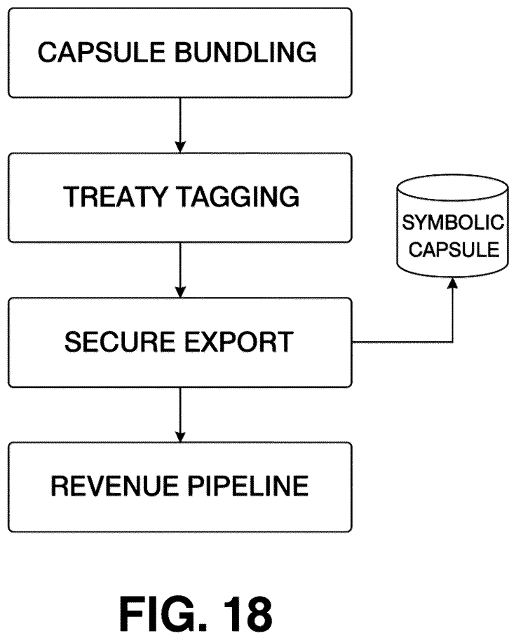

FIG. 19 is a gesture-based agent interface schematic, including wearable symbol tap grid and override gestural lexicon.

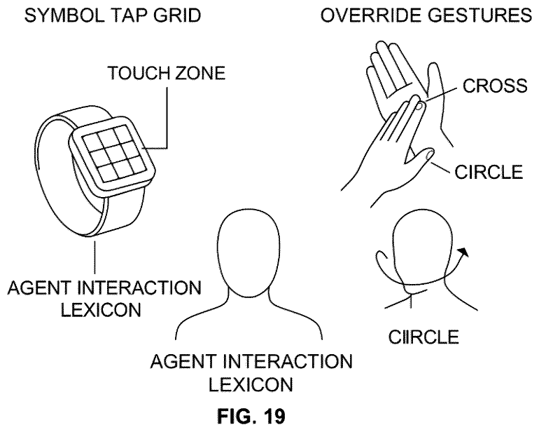

FIG. 20 is a treaty-compliant symbolic capsule export protocol, including audit-path signing, consent steward anchor, and jurisdictional lockbox integration.

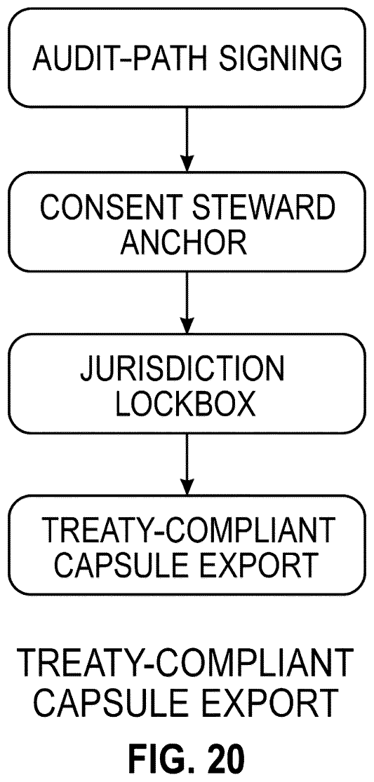

1. A privacy-preserving retail analytics system, comprising:
a 360-degree multimodal sensing assembly including at least one optical sensor, at least one thermal sensor, and at least one acoustic sensor;
a symbolic execution kernel configured to convert sensor data into non-identifying behavioral glyphs representing posture, trajectory, thermal variation, and interaction intent;
a consent-governed classification module configured to assign each glyph to a consent state selected from a group consisting of explicit, implicit, deferred, revoked, and undefined;
a policy-driven redaction engine implementing a programmable directed acyclic graph (DAG) defining zone-specific, role-specific, and jurisdiction-specific redaction thresholds;
and a hardware-enforced output controller preventing storage, export, or transmission of any non-redacted glyph stream unless permitted by the applicable consent state.

2. A method for non-identifying in-store surveillance and incident detection, the method comprising:
capturing optical, thermal, acoustic, and depth-based sensor data from a retail environment;
transforming the sensor data into symbolic behavioral representations without generating biometric identifiers;
evaluating the symbolic representations against a policy DAG specifying redaction, escalation, and retention criteria;
applying consent-gated filtering to suppress or modify symbolic output according to staff or customer consent state;
and triggering alerts, redaction, or escalation actions only when the symbolic severity score exceeds a programmable threshold.

3. An edge-AI surveillance device, comprising:
a spherical housing containing omnidirectional optical, thermal, and acoustic sensors;
an onboard neuromorphic symbolic processor configured to generate behavior glyphs rather than identity tokens;
a behavior-to-consent mapping module generating consent-governed symbolic output;
and a hardware-encoded redaction subcircuit that blocks non-compliant glyph streams from reaching storage, cloud endpoints, or external analytics systems.

4. The system of claim 1, wherein the symbolic execution kernel constructs a behavior graph comprising nodes encoding posture and movement patterns and edges encoding temporal or spatial transitions.

5. The system of claim 1, wherein the policy DAG triggers automatic redaction when the subject posture or thermal signature matches a privacy-designated gesture class.

6. The system of claim 1, further comprising a thermal anomaly classifier distinguishing human heat signatures from inanimate objects or HVAC interference.

7. The system of claim 1, wherein an alert is generated only when a consent token is revoked, expired, or undefined.

8. The method of claim 2, wherein all symbolic execution paths are hash-logged with cryptographic integrity proofs to support audit replay.

9. The method of claim 2, wherein the policy DAG is reconfigurable by authorized staff via a consent-controlled interface.

10. The method of claim 2, wherein escalation events cause consent-dependent relay of symbolic incident summaries to a management dashboard.

11. The method of claim 2, wherein no biometric identity, facial feature, gait signature, or speech transcript is required to trigger alerts.

12. The method of claim 2, further comprising generating redaction metadata logs for insurance, legal, or regulatory compliance without exporting sensor data.

13. The device of claim 3, wherein the symbolic processor includes hardware-accelerated predicate logic blocks for real-time gesture glyph formation.

14. The device of claim 3, further comprising a removable jurisdiction-specific policy cartridge storing region-specific DAG overlays.

15. The device of claim 3, wherein a local user interface displays encrypted symbolic overlays instead of video feeds.

16. The device of claim 3, wherein the consent module is programmable using a structured policy language comprising YAML, JSON, or equivalent schema.

17. The system of claim 1, wherein employee behaviors are symbolically logged only during authenticated work shifts.

18. The system of claim 1, wherein customer motion vectors are aggregated anonymously to generate behavioral heatmaps without identifying individuals.

19. The method of claim 2, wherein redacted incident summaries include temporal trust scores derived from symbolic entropy.

20. The device of claim 3, wherein the device consumes less than 8 watts during continuous symbolic inference and redaction enforcement.
